(19) United States
(12) Patent Application Publication
(10) Pub. No.: US 2010/0291231 A1
(43) Pub. Date: Nov. 18, 2010

(54) Compositions as Wound Sealant

(75) Inventors: Reinhold Stadler, Kirrweiler (DE); Michael Vonend, Bad Duerkheim (DE); Erich Birner, Altleiningen (DE); Heike Pfistner, Ludwigshafen (DE); Steffen Henkes, Boehl-Iggelheim (DE); Michael Merk, Ludwigshafen (DE); Sven Harmsen, Tiefenthal (DE); Egon Haden, Ludwigshafen (DE)

Correspondence Address: BRINKS, HOFER, GILSON & LIONE, P.O. BOX 110285, RESEARCH TRIANGLE PARK, NC, 27709, US

(73) Assignee: BASF SE, Ludwigshafen (DE)

(21) Appl. No.: 12/679,355

(22) PCT Filed: Sep. 23, 2008
(86) PCT No.: PCT/EP2008/062685

§ 371 Date: Jun. 24, 2010

(30) Foreign Application Priority Data
Sep. 24, 2007 (EP) 07117088.0

(51) Int. Cl. A01N 59/26; A01N 43/56; A01P 3/00; A01P 7/04; A01P 15/00; A01N 43/60; A01N 43/40; A01N 43/54; A01N 43/50; A01N 59/20; A01N 59/02; A01N 43/30; A01N 37/18; A01N 47/28; A01N 35/04; A01N 43/76; A01N 43/653

(52) U.S. Cl. 424/605; 514/407; 514/252.12; 514/357; 514/269; 514/399; 424/637; 424/633; 424/632; 424/705; 514/462; 514/617; 514/528; 514/687; 514/376; 514/384

(57) ABSTRACT

The present invention relates to compositions which, in sprayable or form, are suitable as wound sealants for woody plants. The invention also relates to a method of protecting woody plants from infection with phytopathogenic fungi, in particular ESCA infection, using such wound sealants.

These compositions comprise:
a) a water-insoluble sealing agent in dissolved or dispersed form, which is selected among film-forming water-insoluble polymers, waxes and their mixtures;
b) at least one plant protectant,
c) at least one volatile diluent, in particular an aqueous diluent, and, if appropriate,
d) at least one nonionic surface-active substance in an amount of from 10 to 100% by weight, in particular 10 to 80% by weight, based on the sealing agent.

The present invention relates to compositions in liquid, in particular sprayable form, which are suitable as wound sealants for woody plants. The invention also relates to a method of protecting woody plants from infection with phytopathogenic fungi, in particular esca infection, using such wound sealants.

Woody plants are exposed not only to climatic factors, but also to attack by pests. These include bacteria, yeasts, viruses, but mainly insects and harmful fungi. These exploit the wood surface which is not protected by any bark or cortex, or wounds in the woody part of woody plants, in order to penetrate. The wood is damaged. A sufficient protection of surfaces and pores and wounds in the wood of plants is therefore required.

It is known that a series of plant pathogens such as bacteria, yeasts, viruses, but mainly harmful fungi, penetrate into wounds of woody parts as they are inflicted for example by the routine pruning of fruiting trees or by browsing game and by grafting methods, from where they infect all of the plant. Such an infection can lead to quality losses of the wood, to disease of the plant, or to reduced yields, indeed to the loss of the fruit-bearing capacity of the woody parts, or the dying of the plant. This damage is frequently irreversible. To avoid such infections via the wound, wounds in woody parts are, as a rule, sealed against air and water with the aid of, for example, waxy pruning compound.

It has been known since the thirties of the last century to seal wounds in wood, for example pruning wounds in grapevines, with tar or a substance with disinfecting activity. A variety of resin-like substances have been employed for the surface treatment and for sealing wounds in plants. At the beginning, tar or bitumen was preferred. However, these materials become brittle over time and permit a later attack by the pathogens.

In recent times, a variety of latex-like substances, polymers or polymer/resin mixtures have been described as wound sealants for wood surfaces in trees (see, for example, DE 35 37516, DD 290 350, GB 2090851). As a rule, these agents are highly viscous, as is the case with tar or bitumen, and their application is only meaningful in wounds which cover a large area. An efficient application, for example by spraying, is not possible.

BE 0 100 1499, in turn, describes a method of treating, or controlling, wound diseases in perennials by the application of an oily, anhydrous formulation which comprises a fungicide or bactericide. This formulation comprises in particular a conazole fungicide such as cyproconazole in an oily matrix together with a thixotropic adjuvant (liquefied by shear forces), which is preferably a thickener. The durability of the wound seal obtained thereby is not satisfactory.

WO 87/00399 and WO 87/00400 describe wound sealants for woody plants which comprises a fungicidal active substance, a resin and a product obtained by reacting alkyl methacrylates in the presence of inhibitors. However, these compositions are not without health risks due to the high content of alkyl methacrylate monomers and volatile oligomers. Also, storage may result in degradation of the inhibitor and in spontaneous polymerization, which results in the composition becoming useless.

WO 2006/100259 describes the use of aqueous compositions which comprise a silicone oil which is crosslinkable by condensation, if appropriate a crosslinking agent and if appropriate a plant protectant. Owing to the ability of the silicones to polymerize, the storage stability is limited.

In recent times, the wood disease esca on grapevines has increasingly led to problems in viticulture. Esca comprises a complex of fungal pathogens. The pathogens which, according to the literature, are associated with esca symptoms are Fomitiporia punctata (syn. Phellinus punctatus), Fomitiporia mediterrana, Phaeoacremonium spp.: Phaeoacremonium aleophilum and Phaemoniella chlamydosporum. A particular fungus which has been isolated from the wood of esca-infected grapevines is Fomitiporia mediterrana (white rot).

The infection of grapevines with the pathogens takes place via wounds, in particular via cuts, which are susceptible to infections over several months. The air-borne spores or conidia arrive on the cuts and grow into the grapevines. The infestation of the woody part of the plant takes place for several years before the first symptoms become apparent. The wood decays, and the vascular bundles are destroyed.

No effective protective measures against esca are known to date, with the exception of minimizing the infection potential, by removing infected wood from the plantation. Mechanical protection of the exposed areas following the pruning of the grapevines can be obtained by applying wound sealants to the pruning sites, which prevents pathogen penetration.

Das Deutsche Weinmagazin, pp. 12 to 15, 1/6th January 2007 describes the use of wound-sealing materials such as resinous pruning compounds for the protective treatment of esca infection and white rot in viticulture. Depending on the formulation, the application may be carried out by means of pruning-spraying shears. The protection obtained, however, is not entirely satisfactory.

The earlier international patent application PCT/EP 2007/052643 describes the use of strobilurins for the curative and the protective treatment of esca infections.

Accordingly, it is the object of the present invention to provide a wound sealant for wounds in woody plants, hereinbelow also referred to as “surface sealant”, which overcomes the shortcomings of the prior art and which is suitable in particular for the protective treatment of fungal pathogens on woody plants and specifically for the treatment of esca in grapevines.

This object is achieved by liquid, in particular sprayable compositions which comprise
a) a water-insoluble sealing material in dissolved or dispersed form which is selected from among film-forming water-insoluble polymers, waxes and their mixtures;
b) at least one plant protectant which is preferably selected from the group of the strobilurins and the group of the sterol biosynthesis demethylation inhibitors (DMI fungicides), in particular at least one active ingredient from the group of the strobilurins and specifically pyraclostrobin,
c) at least one volatile diluent, in particular an aqueous diluent, and
d) at least one nonionic surface-active substance in an amount of from 10 to 100% by weight, in particular from 10 to 80% by weight, based on the sealing material.

Accordingly, a first subject matter of the invention relates to such a liquid composition, in particular sprayable compositions. Likewise a subject matter of the invention is the use of such liquid, in particular sprayable compositions as wound sealants for wounds in woody plants.

Such compositions are distinguished by the fact that they are simple to handle, they can also be employed, if appropriate after dilution to a sprayable consistency, in automated spraying methods, and they are capable of being applied extensively. They are distinguished by a good adhesion of the sealing material to woody surfaces, in particular to wounds of woody plants.

Moreover, the compositions according to the invention are distinguished by an increased penetration of the sealing material and/or of the active ingredient into the woody substance in the wound area and therefore permit a particularly long-lasting and efficient protection from an infection, or an attack, of the plant with/by plant pathogens (protective treatment). If the compositions comprise a fungicidal active ingredient, they are particularly suitable for protecting woody plants from infection with phytopathogenic fungi, in particular from esca infection. Owing to the increased penetration of the composition into the woody substance in the wound area, the compositions according to the invention are also suitable in particular for the protective treatment of pathogen-caused diseases on woody plants, in particular diseases caused by phytopathogenic fungi (curative treatment), and specifically for the treatment of esca in grapevines. Moreover, the compositions are storage-stable, and, as a rule, they do not comprise any components capable of polymerization, such as monomers. Furthermore, the compositions according to the invention have a good freeze-thaw stability.

Accordingly, a further subject matter of the invention is a method of protecting woody plants from infection with, or attack by, plant pathogens, in particular from an infection with phytopathogenic fungi and specifically esca infection in grapevines, comprising the application of the liquid composition according to the invention, if appropriate after dilution of the liquid composition with water to a sprayable consistency, to wounds in woody plants, specifically to wounds in grapevines.

Accordingly, a further subject matter of the invention is a method of treating woody plants which are infected with, or attacked by, plant pathogens, in particular phytopathogenic fungi, and in particular for the treatment of esca infection, comprising the application of the liquid composition according to the invention, if appropriate after dilution of the liquid composition with water to a sprayable consistency, to wounds in woody plants, specifically to wounds in grapevines.

The term “sprayable” means that the composition is highly liquid (has low viscosity) at ambient temperature (for example at 20° C.) and can be applied with spraying apparatuses. As a rule, the dynamic viscosity of the sprayable composition at 20° C. will not exceed a value of 500 mPa·s (Brookfield determination as specified in DIN EN ISO 1652) and frequently have a value in the range of from 1 to 500 mPa·s, preferably in the range from 1.5 to 400 mPa·s and in particular in the range of from 2 to 300 mPa·s. Preferably, the dynamic viscosity of the sprayable composition at 10° C. will not exceed a value of 500 mPa·s (Brookfield-determination as specified in DIN EN ISO 1652) and will frequently have a value in the range of from 1 to 500 mPa·s, preferably in the range from 1.5 to 400 mPa·s and in particular in the range of from 2 to 300 mPa·s. Preferably, the dynamic viscosity of the sprayable composition at 4° C. will not exceed a value of 500 mPa·s (Brookfield-determination as specified in DIN EN ISO 1652) and will frequently have a value in the range of from 1 to 500 mPa·s, preferably in the range from 1.5 to 400 mPa·s and in particular in the range of from 2 to 300 mPa·s.

The term “flowable” or “liquid” means that the composition is liquid (has low or medium viscosity) at ambient temperature (for example 20° C.). As a rule, the dynamic viscosity of a liquid composition at 20° C. will not exceed a value of 2000 mPa·s (Brookfield-determination as specified in Din EN ISO 1652 at 20° C.) and will frequently have a value in the range of from 2 to 2000 mPa·s. In a first embodiment of the invention, the flowable composition according to the invention is highly liquid, i.e. it has a viscosity in the range of from 1 to 500 mPa·s. In a second embodiment of the invention, the flowable composition according to the invention is of medium viscosity, i.e. it has a viscosity in the range of from 500 to 2000 mPa·s.

It is advantageous for the compositions according to the invention to form, at the lowest possible temperatures, a coherent film when the volatile diluent dries, i.e. to have a low minimum filming temperature. The minimum filming temperature (MFT) is the temperature below which a composition does not form a coherent film upon drying. The MFT is determined as specified in DIN ISO 2115. Accordingly, the MFT of the compositions, determined as specified in DIN ISO 2115, is preferably not more than 30° C., in particular not more than 20° C., especially preferably not more than 10° C. and specifically not more than 5° C. The minimum filming temperature depends in a manner known per se on the melting point or on the glass transition temperature of the polymeric or waxy sealing material and can, if required, be adjusted by addition of plastifying substances, for example slow-evaporating unpolar organic solvents with a boiling point of about 200° C., for example high-boiling hydrocarbon fractions, di-C₂-C₁₄-alkyl esters of aliphatic, cycloaliphatic or aromatic dicarboxylic acids, nonionic emulsifiers.

In a preferred embodiment the sealing material does not comprise any polymerizable substances such as ethylenically unsaturated monomers or crosslinkable siloxane oligomers.

In a preferred embodiment, the compositions are essentially free from substances capable of polymerization, such as ethylenically unsaturated monomers. Based on their total weight, the compositions preferably comprise not more than 0.1% by weight, in particular not more than 0.01% by weight, of substances capable of polymerization, such as monomers.

In one embodiment, the compositions comprise no crosslinking inhibitor.

In one embodiment, the compositions comprise no or less than 5% by weight, in particular less than 1% by weight, of water-insoluble inorganic solids, such as for example fillers such as silicon dioxide, silicates, aluminas, aluminosilicates, calcium carbonate, barite, titanium dioxide and the like.

Preferably, the constituents a), b), c) and d) amount to at least 95% by weight, in particular at least 99% by weight or at least 99.9% by weight, based on the total weight of the composition.

The sealing of the wound is brought about by the water-insoluble sealing material which is present in the composition. Depending on the chosen solvent or diluent c), the water-insoluble sealing material is present in dissolved or dispersed form. The term “water-insoluble” means that the solubility of the sealing material in water is negligible, i.e. the solubility in deionized water at pH 3-12 and 20° C. is less than 0.1 g/l, specifically less than 10 ppm.

Compositions in which the sealing material is present in dispersed form, i.e. the sealing material is present in the volatile diluent c) in the form of dispersed particle, are preferred in accordance with the invention. As a rule, the dispersed particles of the sealing material have particle sizes of not more than 2 μm, in particular not more than 1 μm and specifically not more than 500 nm, and are for example in the range of from 10 nm to 1000 nm, in particular in the range from 20 to 500 nm and specifically in the range of from 50 to 250 nm. The particle sizes detailed herein are weight-average particle sizes as they can be determined by dynamic light scattering. Methods in this context are known to the skilled worker, for example from H. Wiese in D. Distler, Wässrige Polymerdispersionen, Wiley-VCH 1999, Kapitel 4.2.1, p. 40 et seq. and literature cited therein, and H. Auweter, D. Horn, J. Colloid Interf. Sci. 105 (1985) 399, D. Lilge, D. Horn, Colloid Polym. Sci. 269 (1991) 704 or H. Wiese, D. Horn, J. Chem. Phys. 94 (1991) 6429.

Sealing materials which are suitable in accordance with the invention are polymers and waxes and mixtures thereof.

If the sealing material is a polymer, the polymer will be preferably not crosslinked or weakly crosslinked, in order to achieve good film formation. If the polymers have a glass transition temperature, this is preferably below 50° C. and in particular below 30° C. (determined by means of DSC (differential scanning calorimetry) as specified in DIN 53765, ASTM D 3418 or DIN EN ISO 11357-2).

Examples of polymers which are suitable as sealing materials according to the invention are polyesters, in particular aliphatic and araliphatic polyesters, polyurethanes, and preferably polymers with a main chain composed of carbon atoms, in particular acrylate polymers such as styrene acrylates and straight acrylates, polyvinyl acetates which will be explained in greater detail hereinbelow, and waxy polymers and mixtures thereof.

Examples of suitable polyesters are condensates of alkanediols and/or polyether diols and aliphatic and/or aromatic dicarboxylic acids, optionally in the presence of trihydric or polyhydric (e.g. tetra-, penta- or hexahydric) alcohols or polycarboxylic acids, for example a polymer obtained by condensation of C₂-C₆-alkanediols and/or di-C₂-C₄-alkylene glycols and terephthalic acid and/or adipic acid.

In one embodiment of the invention the sealing material a) comprises at least one polyurethane. Suitable polyurethanes are the reaction products of di- or polyisocyanates and di- or polyfunctional compounds with at least 2 groups with reactivity to isocyanate, in particular at least 2 hydroxyl groups.

Suitable diisocyanates are those of the formula X(NCO)₂ where X is an aliphatic hydrocarbon radical having 4 to 12 carbon atoms, a cycloaliphatic or aromatic hydrocarbon radical having 6 to 15 carbon atoms or an araliphatic hydrocarbon radical having 7 to 15 carbon atoms. Examples of such diisocyanates are tetramethylene diisocyanate, hexamethylene diisocyanate (HDI), dodecamethylene diisocyanate, 1,4-diisocyanatocyclohexane, 1-isocyanato-3,5,5-trimethyl-5-isocyanatomethylcyclohexane (IPDI), 2,2-bis(4-isocyanatocyclohexyl)propane, trimethylhexane diisocyanate, 1,4-diisocyanatobenzene, 2,4-diisocyanatotoluene, 2,6-diisocyanatotoluene, 4,4′-diisocyanatodiphenylmethane, 2,4′-diisocyanatodiphenylmethane, p-xylylene diisocyanate, tetramethylxylylene diisocyanate (TMXDI), the isomers of bis(4-isocyanatocyclohexyl)methane (HMDI), such as the trans/trans, the cis/cis and the cis/trans isomer, and the mixtures composed of these compounds. Preferred diisocyanates are 1-isocyanato-3,5,5-trimethyl-5-isocyanatomethylcyclohexane (IPDI), tetramethylxylylene diisocyanate (TMXDI), hexamethylene diisocyanate (HDI) and bis-(4-isocyanatocyclohexyl)methane (HMDI). Mixtures of these isocyanates are also suitable, for example, mixtures of the respective structural isomers of diisocyanatotoluene and diisocyanatodiphenylmethane, for example a mixture of 80 mol % of 2,4-diisocyanatotoluene and 20 mol % of 2,6-diisocyanatotoluene, mixtures of aromatic isocyanates such as 2,4-diisocyanatotoluene and/or 2,6-diisocyanatotoluene and aliphatic or cycloaliphatic isocyanates such as hexamethylene diisocyanate or IPDI. Examples of polyisocyanates are the biurets and cyanurates of the abovementioned diisocyanates, and oligomeric products of these diisocyanates which, in addition to the free isocyanate groups, bear further capped isocyanate groups, for example isocyanurate, biuret, urea, allophanate, uretdione or carbodiimide groups.

Compounds with at least 2 hydroxyl groups are low-molecular-weight di- or polyols and polymeric polyols such as polyesterdiols, polycarbonate diols, polyacrylate polyols and polyether diols, and their mixtures. In the interests of good film formation and elasticity, suitable di- or polyols are relatively high-molecular-weight diols whose molar mass is from approximately 500 to 5000 g/mol, preferably from approximately 1000 to 3000 g/mol.

Preferably, the polyurethane is composed to at least 40% by weight, especially preferably to at least 60% by weight and very especially preferably to at least 80% by weight of diisocyanates, polyether diols, polycarbonate diols and/or polyester diols.

Preferably, the polyurethane comprises polyester diols in an amount of more than 10% by weight, especially preferably more than 30% by weight, in particular more than 40% by weight or more than 50% by weight, very especially preferably more than 60% by weight based on the polyurethane. Polyester diols, in particular, are used as structural components. In the event that polyester diols are used in admixture with polyether diols, preferably at least 50 mol %, especially preferably at least 80 mol %, very especially preferably 100 mol %, of the mixture of polyester diols and polyether diols are polyester diols.

To give the polyurethanes their water-dispersibility, the polyurethanes have incorporated by polymerization preferably compounds which bear at least one isocyanate group or at least one group which is reactive towards isocyanate groups, and, in addition, at least one hydrophilic group or one group which can be converted into a hydrophilic group. The (potentially) hydrophilic groups may take the form of nonionic groups such as polyethylene oxide groups, or, preferably, (potentially) ionic hydrophilic groups, for example sulfonate groups or carboxylic groups.

Examples of suitable polyester polyols are the polyester polyols which are known, for example, from Ullmanns Encyklopädie der Technischen Chemie, 4th edition, volume 19, pages 62 to 65. It is preferred to employ polyester polyols which are obtained by reacting dihydric alcohols with divalent carboxylic acids. In the place of the free carboxylic acids, it is also possible to use, to produce the polyester polyols, the corresponding polycarboxylic anhydrides or the corresponding polycarboxylic acid esters of lower alcohols or their mixtures. The polycarboxylic acids may be aliphatic, cycloaliphatic, araliphatic, aromatic or heterocyclic and may be optionally substituted, for example by halogen atoms, and/or unsaturated. Examples which may be mentioned are: suberic acid, azelaic acid, phthalic acid, isophthalic acid, phthalic anhydride, tetrahydrophthalic anhydride, hexahydrophthalic anhydride, tetrachlorophthalic anhydride, endomethylenetetrahydrophthalic anhydride, glutaric anhydride, maleic acid, maleic anhydride, alkenylsuccinic acid, fumaric acid, dimeric fatty acids. Preferred are dicarboxylic acids of the general formula HOOC—(CH₂)_{y}—COOH where y is a number from 1 to 20, preferably an even number from 2 to 20, for example succinic acid, adipic acid, sebacic acid and dodecanedicarboxylic acid.

Diols which are suitable for the preparation of the polyester polyols are, for example, ethylene glycol, propane-1,2-diol, propane-1,3-diol, butane-1,3-diol, butane-1,4-diol, butene-1,4-diol, butyne-1,4-diol, pentane-1,5-diol, neopentyl glycol, bis-(hydroxymethyl)cyclohexanes such as 1,4-bis(hydroxymethyl)cyclohexane, 2-methylpropane-1,3-diol, methylpentanediols, furthermore diethylene glycol, triethylene glycol, tetraethylene glycol, polyethylene glycol, dipropylene glycol, polypropylene glycol, dibutyleneglycol and polybutylene glycols. Preferred are alcohols of the general formula HO—(CH₂)ₓ—OH where x is a number from 2 to 20, preferably an even number from 2 to 12. Examples are ethylene glycol, butane-1,4-diol, hexane-1,6-diol, octane-1,8-diol and dodecane-1,12-diol. Furthermore preferred are neopentyl glycol and pentane-1,5-diol. These diols may also be used as diols directly for the synthesis of the polyurethanes.

Other polyester diols which are suitable are based on lactones, taking the form of lactone homopolymers or mixed polymers, preferably of adducts, having terminal hydroxyl groups of lactones and suitable difunctional starter molecules. Suitable lactones are preferably those which are derived from compounds of the general formula HO—(CH₂)_{z}—COOH where z is a number from 1 to 20 and one H atom of a methylene unit may also be substituted by a C₁- to C₄-alkyl radical. Examples are c-caprolactone, β-propiolactone, γ-butyrolactone and/or methyl-ε-caprolactone and their mixtures. Examples of suitable starter components are the low-molecular-weight divalent alcohols which have been mentioned above as structural component for the polyester polyols. The corresponding polymers of the ε-caprolactone are especially preferred. Others which may be employed as starters for the preparation of the lactone polymers are lower polyester diols or polyether diols. Instead of the lactone polymers, it is also possible to employ the chemically equivalent polycondensates of the hydroxycarboxylic acids which correspond to the lactones.

Also suitable are furthermore polycarbonate diols as can be obtained for example by reacting phosgene with an excess of the low-molecular-weight alcohols mentioned as structural components for the polyester polyols.

Others which are suitable for the preparation of the polyurethanes are polyether diols. In particular, they take the form of polyether diols which can be obtained by homopolymerization of ethylene oxide, propylene oxide, butylene oxide, tetrahydrofuran, styrene oxide or epichlorohydrin, for example in the presence or BF₃, or by an addition reaction of these compounds, if appropriate as a mixture or in succession, with starting components with reactive hydrogen atoms, such as alcohols or amines, for example water, ethylene glycol, propane-1,2-diol, propane-1,3-diol, 1,1-bis(4-hydroxyphenyl)propane or aniline. Especially preferred is polytetrahydrofuran, with a molar mass of 240 to 5000 g/mol, and above all 500 to 4500 g/mol. Besides, it is also possible to employ mixtures of polyester diols and polyether diols as the monomers.

Other substances which are suitable for the preparation of the polyurethanes are polyhydroxypolyolefins and comparable polyhydroxy polymers based on monoethylenically unsaturated monomers, preferably those with 2 terminal hydroxyl groups, for example, α-ω-dihydroxypolybutadiene, α-ω-dihydroxypolymethacrylic esters or α-ω-dihydroxypolyacrylic esters. Such compounds are disclosed for example in EP-A 622 378. Further suitable polyols are polyacetals, polysiloxanes and alkyd resins.

The hardness and the modulus of elasticity of the polyurethanes can be increased by using, as diols, also low-molecular-weight diols with a molar mass of approximately from 60 to 500 g/mol, preferably from 62 to 200 g/mol, in addition to the abovementioned high-molecular-weight diols.

Low-molecular-weight diols which are employed are, above all, the structural components of the short-chain alkanediols mentioned for the preparation of polyester polyols, preference being given to the unbranched diols with 2 to 12 C atoms and an even number of C atoms, and pentane-1,5-diol and neopentyl-glycol. Moreover, suitable diols are phenols or bisphenol A or F.

Other examples of suitable monomers are amino-group-bearing polyfunctional compounds such as hydrazine, hydrazine hydrate, ethylenediamine, propylenediamine, diethylenetriamine, dipropylenetriamine, isophorone diamine, 1,4-cyclohexyldiamine, N-(2-aminoethyl)ethanolamine or piperazine.

Preferably, the polyurethane has a melting point above 30° C., in particular above 40° C., especially preferably above 50° C. or else above 60° C. or above 70° C.; in general, the melting point does not exceed 150° C., in particular not 100° C. Accordingly, the melting point is, in particular within a range of from 30 to 150° C., especially preferably from 40 to 150° C. and very especially preferably from 30 to 100° C. and in particular from 50 to 80° C. The polyurethane preferably has a enthalpy of fusion of more than 20 J/g. The melting point and the enthalpy of fusion are measured by means of DSC. The melting point is typically measured on polyurethane films with a thickness of 200 μm which had been dried for 72 hours at 40° C. in a circulating-air drying oven before taking the measurement. To prepare the measurement, approximately 13 mg of the polyurethane are placed into pans. The pans are sealed, the samples are heated to 120° C., cooled at 20 K/m in and heat-conditioned for 20 hours at 20° C. The samples thus treated are measured by the DSC method as specified in DIN 53765, the sample being heated at 20 K/min. The melting point is evaluated as the peak temperature as specified in DIN 53765, and the enthalpy of fusion is determined as in FIG. 4 of DIN 53765.

In a preferred embodiment, the sealing material is a water-insoluble acrylate polymer, in particular a weakly crosslinked acrylate polymer (acrylate rubber).

Acrylate polymers are understood by the skilled worker as meaning homo- and copolymers of acrylic acid esters, if appropriate together with vinyl-aromatic monomers (styrene acrylates) or with methacrylic acid esters (straight acrylates) as the comonomers. Such acrylate polymers are well known to the skilled worker, for example from Ullmann's Encyclopedia of Industrial Chemistry, 5th ed. on CD-ROM, Wiley-VCH 1997, Polyacrylates (Erich Penzel) and are commercially available for example as solutions or aqueous dispersions under the trade names Acronal® of BASF Aktiengesellschaft, for example the products sold under the trade names Acronal® 290 D, Acronal® A 603, Acronal® S 725 and Acronal® S 260.

As main monomers, the acrylate monomers usually comprise C₁-C₂₀-alkyl (meth)acrylates or a mixture of C₁-C₂₀-alkyl (meth)acrylates with vinyl esters of carboxylic acids comprising up to 20 C atoms, vinylaromatics with up to 20 C atoms, monoethylenically unsaturated nitriles, vinyl halides, vinyl ethers of alcohols having 1 to 10 C atoms, aliphatic hydrocarbons having 2 to 8 C atoms and one or two double bonds and which have monodiethylenic or conjugated diethylenic unsaturation, or mixtures of these monomers. The main monomers will, as a rule, account for at least 80% by weight and in particular at least 90% by weight of the monomers of which the acrylate polymer is composed.

The terms “alkyl (meth)acrylate” and “(meth)acrylic ester” comprise not only the (alkyl) esters of acrylic acid, but also those of methacrylic acid. Alkyl (meth)acrylates which may be mentioned are, for example, (meth)acrylic alkyl esters having a C₁-C₁₀-alkyl radical, such as methyl acrylate, ethyl acrylate, n-butyl acrylate, 2-butyl acrylate, tert-butyl acrylate, hexyl acrylate, 2-ethylhexyl acrylate, 2-propylheptyl acrylate, methyl methacrylate, ethyl methacrylate, n-butyl methacrylate, 2-butyl methacrylate, tert-butyl methacrylate, hexyl methacrylate, 2-ethylhexyl methacrylate and 2-propylheptyl methacrylate. Others which are suitable are, in particular, also mixtures of the alkyl (meth)acrylates, for example mixtures of at least 2 alkyl acrylates or mixtures of at least one alkyl acrylate with at least one alkyl methacrylate.

Suitable vinyl-aromatic compounds are vinyltoluene, α- and p-methylstyrene, α-butyl-styrene, 4-n-butylstyrene, 4-n-decylstyrene and, preferably, styrene.

Examples of monoethylenically unsaturated nitriles are acrylonitrile and methacrylonitrile.

Examples of vinyl esters of carboxylic acids having 1 to 20 C atoms are vinyl laurate, vinyl stearate, vinyl propionate, vinyl versatate and, in particular, vinyl acetate.

The vinyl halides are ethylenically unsaturated compounds which are substituted by chlorine, fluorine or bromine, preferably vinyl chloride and vinylidene chloride.

Examples of vinyl ethers which may be mentioned are vinyl methyl ether or vinyl isobutyl ether. Preferred substances are vinyl ethers of alcohols comprising 1 to 4 C atoms.

Aliphatic hydrocarbons which have 2 to 8 C atoms and one or two olefinic double bonds which may be mentioned are ethylene, propylene, butadiene, isoprene and chloroprene.

Preferred main monomers are C₁-C₁₀-alkyl (meth)acrylates (straight acrylates) and mixtures of the C₁-C₁₀-alkyl (meth)acrylates with vinylaromatics, in particular styrene (styrene acrylates).

In the case of the styrene acrylates, the weight ratio of alkyl (meth)acrylates to vinyl aromatics (in particular styrene) may be for example 10:90 to 90:10, preferably 20:80 to 80:20.

Besides the main monomers, the acrylate polymer (hereinbelow also referred to as polyacrylate) may have further monomers incorporated. These include, for example, monoethylenically unsaturated monomers with at least one acid group (hydrophilic acidic monomers) such as carboxylic acid groups, sulfonic acid groups or phosphonic acid groups, and the salts of these monomers, in particular the alkali metal, alkaline-earth metal and ammonium salts. Preferred substances are monoethylenically unsaturated monomers having at least one carboxylic acid group. Examples which may be mentioned are acrylic acid, methacrylic acid, itaconic acid, maleic acid or fumaric acid and aconitic acid. The content of hydrophilic acidic monomers in the polyacrylate generally amounts to no more than 10% by weight. If desired, the amount of hydrophilic acidic monomers is usually in the range of from 0.1 to 10% by weight, in particular in the range of from 0.2 to 5% by weight, based on the total amount of the monomers incorporated in the polyacrylate.

Examples of further monomers are also neutral monoethylenically unsaturated monomers with an elevated water solubility (neutral hydrophilic monomers) of, as a rule, at least 80 g/l (at 25° C.), for example monomers comprising hydroxyl groups, in particular C₂-C₄-hydroxyalkyl (meth)acrylates, esters of (meth)acrylic acid with poly-C₂-C₃-alkylene glycols, monoethylenically unsaturated amides such as (meth)acrylamide and monoethylenically unsaturated monomers with a urea group or an imidazolinone group, such as N-vinylurea or N-(methacryloxy)ethylimidzolin-2-one. The content of neutral hydrophilic monomers in the polyacrylate generally amounts to no more than 10% by weight. If desired, the amount of neutral hydrophilic monomers is usually in the range of from 0.1 to 10% by weight, in particular in the range of from 0.2 to 5% by weight, based on the total amount of the monomers incorporated in the polyacrylate.

Further monomers are in particular compounds which have at least two unconjugated double bonds capable of free-radical polymerization, preferably 2 to 6, especially preferably 2 to 4, very especially preferably 2 to 3 and in particular 2. Such compounds are also referred to as crosslinker monomers. The amount of crosslinker monomers, if desired, is usually in the range of from 0.1 to 10% by weight, in particular in the range of from 0.2 to 5% by weight, based on the total amount of the monomers incorporated in the polyacrylate.

Examples of ethylenically unsaturated functionalities in crosslinker monomers are (meth)acrylic, vinyl ether, vinyl ester, allyl ether and allyl ester groups. Examples of crosslinker monomers are 1,2-ethanediol di(meth)acrylate, 1,3-propanediol di(meth)acrylate, 1,2-propanediol di(meth)acrylate, 1,4-butanediol di(meth)acrylate, 1,6-hexanediol di(meth)acrylate, neopentyl glycol di(meth)acrylate, trimethylolpropanetriol di(meth)acrylate, pentaerythritol tetra(meth)acrylate, 1,4-butanediol divinyl ether, 1,6-hexanediol divinyl ether, 1,4-cyclohexane diol divinyl ether, divinylbenzene, allyl acrylate, allyl methacrylate, methallyl acrylate, methallyl methacrylate, (meth)acrylic acid but-3-en-2-yl ester, (meth)acrylic acid but-2-en-1-yl ester, (meth)acrylic acid 3-methylbut-2-en-1-yl ester, esters of (meth)acrylic acid with geraniol, citronellol, cinnamyl alcohol, glycerol mono- or -diallyl ether, trimethylolpropanemono- or -diallyl ether, ethylene glycol monoallyl ether, diethylene glycol monoallyl ether, propylene glycol monoallyl ether, dipropylene glycol monoallyl ether, 1,3-propanediol monoallyl ether, 1,4-butanediol monoallyl ether and furthermore diallyl itaconate. Preferred are allyl acrylate, divinylbenzene, 1,4-butanediol diacrylate and 1,6-hexanediol diacrylate.

Preferred sealing materials are polyacrylates which are composed of vinyl aromatics, alkyl (meth)acrylates, optionally further hydrophilic monomers such as, for example, (meth)acrylonitrile, (meth)acrylamide and (meth)acrylic acid and, if appropriate, crosslinker monomers. For example, such preferred polyacrylate latices comprise in copolymerized form 20 to 50% by weight of styrene, 30 to 80% by weight of alkyl (meth)acrylates, 0 to 20% by weight of further hydrophilic monomers such as, for example, (meth)acrylonitrile, (meth)acrylamide and (meth)acrylic acid and 0 to 10% by weight, in particular 0.1% to 10% by weight, of crosslinker monomers, the amounts in percent by weight being based on the total weight of the monomer constituting the polyacrylate.

Preferred sealing materials are furthermore polyacrylates which are composed of alkyl (meth)acrylates, optionally further hydrophilic monomers such as, for example, (meth)acrylonitrile, (meth)acrylamide and (meth)acrylic acid and, if appropriate, crosslinker monomers. For example, such preferred polyacrylate latices comprise in copolymerized form 20 to 50% by weight of alkyl methacrylates, 30 to 80% by weight of alkyl acrylates, 0 to 20% by weight further hydrophilic monomers such as, for example, (meth)acrylonitrile, (meth)acrylamide and (meth)acrylic acid and 0 to 10% by weight, in particular 0.1% to 10% by weight, of crosslinker monomers, the amounts in percent by weight being based on the total weight of the monomer constituting the polyacrylate.

As a rule, the polyacrylates are prepared by emulsion polymerization, in which case the polyacrylate is present as an aqueous polymer dispersion (latex). The preparation of aqueous polymer dispersions by the free-radical emulsion polymerization method is known per se (cf. Houben-Weyl, Methoden der organischen Chemie, volume XIV, Makromolekulare Stoffe, loc. cit., pages 133 et seq.).

In an especially preferred embodiment, the sealing material is a polyacrylate which takes the form of an acrylate rubber, i.e. a weakly crosslinked polyacrylate. The preparation of such acrylate rubbers is known to the skilled worker and described for example in EP0099532 as graft base. For example, such preferred polyacrylate rubbers comprise, in copolymerized form, 80% to 100% by weight of alkyl acrylates, 0% to 20% by weight of alkyl methacrylates, 0% to 20% by weight of hydrophilic monomers, such as for example (meth)acrylonitrile, (meth)acrylamide and (meth)acrylic acid and 0% to 10% by weight, in particular 0.1% to 10% by weight of crosslinker monomers, the weight percentages being based on the total weight of the monomers constituting the polyacrylate. In a specific embodiment, the sealing material is a polyalkyl acrylate, e.g. a polybutyl acrylate, in particular a crosslinked polyalkyl acrylate, e.g. a crosslinked polybutyl acrylate, i.e. a polyacrylate which is composed of at least one alkyl acrylate, e.g. n-butyl acrylate and a crosslinker monomer.

The term “alkyl” in connection with alkyl acrylate and alkyl methacrylate denotes a linear or branched alkyl radical having 1 to 20 and more particularly 1 to 10 carbon atoms.

Further suitable sealing materials are homo- or copolymers which are composed of hydrocarbons with conjugated diethylenic unsaturations (hydrocarbons having 2 conjugated double bonds), in particular butadiene, or mixtures of such hydrocarbons with vinyl aromatics, in particular styrene, as the main monomers (in summary also referred to as polybutadiene latex) and, if appropriate, the abovementioned hydrophilic comonomers. As regards the weight ratios of main monomers to hydrophilic comonomers, what has been said above also applies here analogously.

In accordance with a further especially preferred embodiment of the invention, the sealing material is a wax or a waxy polymer. In particular, it takes the form of a wax or waxy polymer which has polar functional groups, for example carboxyl groups, hydroxyl groups, aldehyde groups, keto groups, polyether groups or the like, which groups support the dispersing of the waxy component. In particular, the wax or the waxy polymer has carboxyl groups capable of neutralization. Advantageously, the wax or waxy polymer has an acid number of at least 1 mg KOH/g and in particular in the range of from 5 to 250 mg KOH/g, determined as specified in DIN EN ISO 2114.

Suitable waxes are in particular those with a melting point of preferably at least 40° C., in particular at least 60° C. and specifically at least 75° C., for example those with a melting point in the range of from 40° C. to 150° C., in particular in the range of from 60° C. to 140° C., very especially preferably in the range of from 75° C. to 135° C., determined by the DSC method as specified in DIN 53765, see also DIN 51007.

The waxes may be natural waxes or synthetic waxes.

Examples of natural waxes which may be mentioned are beeswax, carnauba wax, candelilla wax, bark wax, ouricouri wax, sugarcane wax, montan acid and ester wax, and cork wax.

Examples of synthetic waxes which may be mentioned are Fischer-Tropsch waxes, paraffins and waxy polymers such as polyolefin waxes, in particular polyethylene waxes, or ethylene copolymer waxes, as they can be obtained for example by free-radical polymerization of ethylene, or free-radical copolymerization of ethylene with, and for example, (meth)acrylic acid or (meth)acrylic acid esters, or by polymerization with the aid of Ziegler-Natta catalysts or metallocene catalysts, partially oxidized waxes, in particular partially oxidized polyolefin waxes. Polyisobutylene waxes may furthermore be mentioned. Other substances which may be mentioned are paraffin mixtures; this is understood as meaning mixtures of hydrocarbons which have 12 or more carbon atoms and a melting point of at least 40° C., preferably in the range of from 40° C. to 150° C., especially preferably those with a melting point in the range of from 60° C. to 140° C., very especially preferably those with a melting point in the range of from 75° C. to 135° C.

In this context, the term “polyethylene waxes” comprises not only homopolymer waxes of ethylene, but also copolymers of polyethylene with in total up to 20% by weight of olefinic comonomers such as, for example, propylene, 1-butene, 1-pentene, 1-hexene, 1-octene, 1-decene or 1-dodecene.

Suitable sealing materials are, in particular, polar polyolefin waxes, in particular polar polyethylene waxes. The polar polyolefin waxes bear carboxyl groups and have, as a rule, an acid number of at least 1 mg KOH/g, preferably at least 5 mg KOH/g and in particular in the range of from 1 to 250 mg KOH/g or 5 to 150 mg KOH/g, determined as specified in DIN EN ISO 2114.

The polar polyolefin waxes include firstly the oxidation products of unpolar polyolefin waxes (known as oxidate waxes, or polyolefin oxidates), for example oxidation products of polyethylene waxes (polyethylene oxidates) or of polypropylene waxes, oxidates of Fischer-Tropsch waxes and carboxyl-group-bearing copolymers of olefins, in particular of C₂-C₆-olefins such as ethylene or propene, with oxygen-group-bearing monomers, for example monoethylenically unsaturated C₃-C₆-monocarboxylic acids such as acrylic acid or methacrylic acid and, if appropriate, vinyl esters of aliphatic C₂-C₁₀-carboxylic acids such as vinyl acetate or vinyl propionate, esters of monoethylenically unsaturated C₃-C₆-monocarboxylic acids with C₁-C₁₈-alkanols or C₅-C₁₂-cycloalkanols, in particular esters of acrylic acid or of methacrylic acid such as methyl acrylate, ethyl acrylate, n-propyl acrylate, isopropyl acrylate, n-butyl acrylate, 2-butyl acrylate, tert-butyl acrylate, n-hexyl acrylate, 2-ethyl hexylacrylate, 3-propyl heptylacrylate, cyclopentyl acrylate, cyclohexyl acrylate and the corresponding esters of methacrylic acid. The polar polyolefin waxes furthermore include the oxidation products of the abovementioned olefin copolymers.

In a particularly preferred embodiment, the sealing material comprises at least one polar wax which is selected among wax oxidates and carboxyl-group-comprising copolymers of ethylene. In particular, the sealing material comprises at least 50% by weight, in particular at least 80% by weight and in particular at least 90% by weight, based on the total weight of the wax constituents present in the dispersion, of at least one polar wax, in particular a polar polyolefin wax which is preferably selected among wax oxidates, specifically polyethylene wax oxidates, and carboxyl-group-comprising copolymers of ethylene.

In particular, the polar polyolefin wax is selected among partially oxidized polyethylene wax which has an acid number in the abovementioned ranges, and olefin copolymers which bear polar carboxyl groups, in particular carboxyl-group-bearing copolymers of ethylene, and their oxidates, the olefin copolymers being essentially composed of:
i) 50 to 99% by weight, in particular 60 to 95% by weight and specifically 70 to 90% by weight of at least one C₂-C₆-olefin, in particular propene, ethene or their mixtures, specifically ethene;
ii) 1 to 50% by weight, in particular 5 to 40% by weight and specifically 10 to 30% by weight of at least one monoethylenically unsaturated C₃-C₆-monocarboxylic acid such as acrylic acid or methacrylic acid and/or C₄-C₆-dicarboxylic acid such as maleic acid, fumaric acid, itaconic acid or a mixture of these specifically acrylic acid, methacrylic acid and/or maleic acid;
   or of
i) 50 to 98% by weight, in particular 60 to 93% by weight and specifically 70 to 89% by weight of at least one C₂-C₆-olefin, in particular propene, ethene or their mixtures, specifically ethene;
ii) 1 to 50% by weight, in particular 5 to 40% by weight and specifically 10 to 29% by weight of at least one monoethylenically unsaturated C₃-C₆-monocarboxylic acid such as acrylic acid or methacrylic acid and/or C₄-C₆-dicarboxylic acid such as maleic acid, fumaric acid, itaconic acid or a mixture of these specifically acrylic acid, methacrylic acid and/or maleic acid; or of
iii) 1 to 30% by weight, for example 2 to 20% by weight, in particular 2 to 15% by weight, of one or more monoethylenically unsaturated monomers which are selected among the esters of monoethylenically unsaturated C₃-C₆-monocarboxylic acids with C₁-C₁₅-alkanols or C₅-C₁₂-cycloalkanols, the diesters of monoethylenically unsaturated C₄-C₈-dicarboxylic acids with C₁-C₁₈-alkanols or C₅-C₁₂-cycloalkanols, in particular esters of acrylic acid or of methacrylic acid, with C₁-C₁₈-alkanols or C₅-C₁₂-cycloalkanols, and among vinyl esters of aliphatic C₂-C₁₈-carboxylic acids, such as vinyl acetate or vinyl propionate.

The monomer proportions detailed herein refer in each case to the total weight of the monomers constituting the polar polyolefin wax. “Essentially” means in this context that the polymers are composed to at least 95% by weight, in particular to at least 99% by weight and specifically exclusively of the abovementioned monomers a), b) and, if appropriate, c). However, the skilled worker knows that such polymers may additionally comprise components of the polymerization catalyst (initiator), in addition to the monomer components.

The polar polyolefin waxes typically have a weight-average molecular weight in the range of from 1000 to 150 000 daltons, frequently in the range of from 2000 to 120 000 daltons. In the case of waxes which melt without decomposition, or of waxy polymers with low to medium molecular weight, these are characterized by a melt viscosity at 140° C. in the range of from 100 to 10 000 mm²/sec (DFG standard method C-IV7 (68) or, with nonmelting waxy polymers, by a minimum melt flow index MFI of at least 1 (at 160° C. under a load of 325 g according to DIN 53753).

The abovementioned wax components are known well from the prior art, for example from Ullmann's Encyclopedia of Industrial Chemistry, 5th ed. on CD-ROM, Wiley VCH, Weinheim 1997, chapter Wachse [Waxes], in particular, section 3 “Montanwachse” [montan waxes] and section 6 “Polyolefinwachse” [polyolefin waxes], and from DE-A 3420168, DE-A 3512564 (waxy copolymers), and from Kunststoffhandbuch volume 4, p. 161 et seq., Karl-Hanser-Verlag, 1969, and the literature cited therein, DE-A 2126725, DE 2035706, EP-A 28384, DE-A 1495938, DE-A 1520008, DE-A 1570652, DE-A 3112163, DE-A 3720952, DE-A 3720953, DE-A 3238652 and WO97/41158. Such products are also commercially available, for example under the trade name Luwax® OA types or Luwax® EAS types from BASF, Licowax PED from Clariant, AC3 . . . and AC6 . . . types from Honeywell, and the AC5 . . . types from Honeywell.

The polar polyolefin waxes employed as sealing materials are typically employed in the form of aqueous dispersions in which the wax particles have the above-mentioned mean particle sizes. The waxes are preferably present in these dispersions in at least partially neutralized form, i.e. at least some, preferably at least 60 mol %, of the carboxyl groups in the polar polyolefin wax are neutralized with a base. The base may also be present in an excess, based on the acid groups, in the polar polyolefin wax in the aqueous wax dispersions, for example in an excess of up to 100 mol %, preferably up to 50 mol %, based on the amount of base required for neutralizing all acid groups in the wax dispersion. Such wax dispersions usually have a neutral to basic pH, preferably pH values in the range of from 6 to 12 and in particular in the range of from 7 to 11.5. Accordingly, such wax dispersions usually comprise one or more substances with the activity of a base, for example hydroxides and/or carbonates and/or hydrogen carbonates of alkali metals, or preferably amines such as, for example ammonia and organic amines such as, for example, alkylamines, N-alkylethanolamines, alkanolamines and polyamines. Examples of alkylamines which may be mentioned are: triethylamine, diethylamine, ethylamine, trimethylamine, dimethylamine, methylamine. Preferred amines are monoalkanolamines, N,N-dialkylalkanolamines, N-alkylalkanol-amines, dialkanolamines, N-alkylalkanolamines and trialkanolamines with in each case 2 to 18 C atoms in the hydroxyalkyl moiety and, if appropriate, in each case 1 to 6 C atoms in the alkyl moiety, preferably 2 to 6 C atoms in the alkanol moiety and, if appropriate, 1 or 2 C atoms in the alkyl moiety. Very especially preferred are ethanolamine, diethanolamine, triethanolamine, methyldiethanolamine, n-butyldiethanolamine, N,N-dimethylethanolamine and 2-amino-2-methylpropan-1-ol. Very especially preferred are ammonia and N,N-dimethylethanolamine. Examples of polyamines which may be mentioned are: ethylenediamine, tetramethylethylene-diamine (TMEDA), diethylenetriamine, triethylenetetramine.

The amount of sealing material in the compositions according to the invention will as a rule not exceed a value of 40% by weight based on the total weight of the composition and is frequently in the range of from 1 to 40% by weight, in particular 2 to 35% by weight or 5 to 30% by weight, in each case based on the total weight of the composition. In principle, lower concentrations of sealing material are also feasible in sprayable compositions, for example in the range of from 0.1 to 40% by weight, in particular in the range of from 0.5 to 30% by weight or in the range from 1 to 20% by weight, in each case based on the total weight of the composition.

Besides the sealing material, the composition according to the invention will, as a rule, comprise at least one active ingredient for plant protection (=plant protectant), preferably at least one active ingredient selected amongst strobilurins and conazole fungicides, in particular at least one active ingredient selected among strobiliurins and specifically pyraclostrobin.

The compositions according to the invention comprise the at least one plant protectant b) in an amount such that the weight ratio of active ingredient to sealing material is in the range from 1:10⁶ to 1:1, frequently in the range from 1:10⁵ to 1:1 or in the range from 1:10⁴ to 1:1, preferably in the range from 100:1 to 1:1 and especially in the range from 1:80 to 1:2 and specifically in the range from 1:50 to 1:5. The amount of active ingredient in the compositions according to the invention is preferably chosen such that the weight ratio of active ingredient to sealing material is in the range of from 1:100 to 1:1 and particularly in the range of from 1:80 to 1:2 and specifically in the range of from 1:50 to 1:5. The concentration of active ingredient in the composition will, as a rule, not exceed a value of 20% by weight, based on the total weight of the composition, and is generally in the range from 0.00001% to 20% by weight, frequently in the range from 0.0001% to 20% by weight or in the range from 0.001% to 20% by weight, or in the range from 0.01% to 20% by weight, preferably in the range of from 0.05 to 20% by weight, in particular 0.1 to 15% by weight or 0.2 to 10% by weight, in each case based on the total weight of the composition. In principle, lower concentrations of active ingredient are also feasible in sprayable compositions, for example in the range of from 0.01 to 20% by weight, in particular in the range of from 0.02 to 10% by weight or in the range of from 0.05 to 5% by weight.

Examples of plant protectants are, in particular, those active ingredients which are known to be suitable for the treatment of diseased woody plants or for the protection of the woody plant from a disease which is caused by attack with plant pathogens such as insects, bacteria, viruses, yeasts or fungi. Accordingly, the term “plant protectant” comprises both biostatically or biocidally active substances, for example bacteriostatically and/or fungistatically active substances, and substances which interfere with the development of insects (for example juvenile hormones), and in particular bactericides, insecticides and fungicides.

In one embodiment, the compositions according to the invention comprise at least one plant protectant selected from among bactericides, insecticides, fungicides, and substances which are active against yeasts or against viruses. The skilled worker is familiar with such active ingredients. Combinations of the abovementioned active ingredients may also be present.

In a preferred embodiment, the compositions according to the invention comprise at least one active ingredient selected among insecticides, fungicides and combinations of insecticides and fungicides.

In a specific embodiment, the compositions according to the invention comprise at least one active ingredient selected among fungicides or a combination of at least one insecticide with at least one fungicide as plant protectant b). The amount of the at least one fungicidally active ingredient is preferably chosen such that the weight ratio of active ingredient to sealing material in the compositions according to the invention is in the range from 1:100 to 1:1 and particularly in the range from 1:80 to 1:2 and specifically in the range from 1:50 to 1:5.

Examples of fungicides which are suitable as plant protectants are: sterol biosynthesis methylation inhibitors (DMIs), for example fungicides from the group of the azoles, in particular conazoles (i.e. azoles with a triazole ring or an imidazole ring), from the group of the piperazines, pyridines and imidazoles such as Perfurazoate, Triforine, Pyrifenox, Fenarimol, Imazalil, Prochloraz and Triflumizoel; carboxamides and carboxanilides; nitrogen-comprising heterocyclyl compounds; strobilurins and ool fungicides; carbamates and dithiocarbamates; methylbenzimidazoles; DMIs, guanidines, antibiotics; organometal compounds; sulfur-comprising heterocyclyl compounds; organophosphorus compounds, phosphorous acid and its salts; organochlorine compounds, nitrophenyl derivatives; inorganic active ingredients such as Bordeaux mixture, copper acetate, copper hydroxide, copper oxychloride, basic copper sulfate, sulfur; spiroxamine, cyflufenamid, cymoxanil or metrafenone.

Compositions according to the invention preferably comprise at least one plant protectant useful for treatment or for protection against wood diseases such as esca or for protection against infection with other harmful fungi or insects and/or for treatment of wood plants infected with esca, other harmful fungi and/or insects.

Preferred fungicides are those which are active against wood diseases. Especially preferred fungicides are those which are active against the esca-associated complex of wood diseases. The especially preferred fungicides are those from the strobilurin group. Also especially preferred are fungicides from the conazole fungicide group, specifically those with a triazole structure. Such fungicides are effective for treatment of wood diseases associated with esca.

In a specific embodiment, the compositions according to the invention comprise at least two fungicides, preferably two fungicides, of which at least one is selected from the group of the strobilurins and at least one further one is selected from fungicides other than strobilurins, for example from among DMI fungicides, preferably from the group of the conazole fungicides, specifically those with triazole structure.

In a specific embodiment, the composition according to the invention comprises at least one fungicidal active ingredient which engages in the mitochondrial respiratory chain at the level of the b/c₁ complex. Active ingredients which inhibit the mitochondrial respiratory chain at this site are known in the art, especially as fungicides (see, for example, Dechema monographs Vol. 129, 27-38, VCH Verlagsgemeinschaft Weinheim 1993; Natural Product Reports 1993, 565-574; Biochem. Soc. Trans. 22, 63S (1993)). An especially important active ingredient class which engages in the mitochondrial respiratory chain at the b/cᵢ complex level, and preferably may be present as component in the compositions according to the invention, are strobilurins.

Strobilurins have been known as fungicides for some time, but have also been described as insecticides (EP-A 178 826; EP-A 253 213; WO 93/15046; WO 95/18789; WO 95/21153; WO 95/21154; WO 95/24396; WO 96/01256; WO 97/15552; WO 97/27189). A further example of such a respiratory chain inhibitor is famoxadone (5-methyl-5-(4-phenoxyphenyl)-3-(phenylamino)-2,4-oxazolidinedione).

In a preferred embodiment of the present invention, the compositions according to the invention comprise at least one strobilurin, if appropriate in combination with at least one further active ingredient which is suitable for the protection or treatment of esca diseases in woody plants, in particular in grapevines.

In one further preferred embodiment of the present invention, the compositions according to the invention comprise at least one strobilurin in combination with at least one further active ingredient useful for protection or treatment of bacterial and/or viral infections in woody plants, particularly in grapevines.

In a further preferred embodiment of the present invention, the compositions according to the invention comprise at least one strobilurin in combination with at least one further active ingredient useful for protection and/or treatment of insect infestation in woody plants, particularly in grapevines.

Strobilurins are in particular:

1) active ingredients which are described by the general formula I:

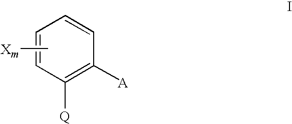

in which
X is a halogen, C₁-C₄-alkyl or trifluoromethyl;
m is 0 or 1;
Q is C(═CH—CH₃)—COOCH₃, C(═CH—OCH₃)—COOCH₃, C(═N—OCH₃)—CONHCH₃, C(═N—OCH₃)—COOCH₃, N(—OCH₃)—COOCH₃, or a group Q1

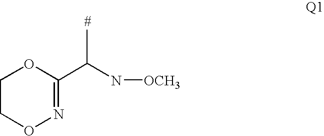

where # denotes the bind to the phenyl ring;
A is —O—B, —CH₂O—B, —OCH₂—B, —CH₂S—B, —CH═CH—B, —C≡C—B, —CH₂O—N═C(R¹)—B, —CH₂S—N═C(R¹)—B, —CH₂O—N═C(R¹)—CH═CH—B, or —CH₂O—N═C(R¹)—C(R²)═N—OR³, where
B is phenyl, naphthyl, heteroaryl having 5 to 6 members or heterocyclyl having 5 or 6 members, comprising one, two or three N atoms and/or one O or S atom or one or two O and/or S atoms, it being possible for the ring system to be unsubstituted or substituted by one, two or three radicals R^{a}:
   R^{a} is, independently, cyano, nitro, amino, aminocarbonyl, aminothiocarbonyl, halogen, C₁-C₆-alkyl, C₁-C₆-haloalkyl, C₁-C₆-alkylcarbonyl, C₁-C₆-alkyl-sulfonyl, C₁-C₆-alkylsulfinyl, C₃-C₆-cycloalkyl, C₁-C₆-alkoxy, C₁-C₆-halo-alkoxy, C₁-C₆-alkyloxycarbonyl, C₁-C₆-alkylthio, C₁-C₆-alkylamino, di-C₁-C₆-alkylamino, C₁-C₆-alkylaminocarbonyl, di-C₁-C₆-alkylaminocarbonyl, C₁-C₆-alkylaminothiocarbonyl, di-C₁-C₆-alkylaminothiocarbonyl, C₂-C₆-alkenyl, C₂-C₆-alkenyloxy, phenyl, phenoxy, benzyl, benzyloxy, 5- or 6-membered heterocyclyl, 5- or 6-membered heteroaryl, 5- or 6-membered heteroaryloxy, C(═NOR^{A})—R^{B} or OC(R^{A})₂—C(R^{B})═NOR^{B}, it being possible for the cyclic radicals to be unsubstituted or to be substituted by one, two or three radicals R^{b};
   R^{b} is, independently, cyano, nitro, Amino, aminocarbonyl, aminothiocarbonyl, halogen, C₁-C₆-alkyl, C₁-C₆-haloalkyl, C₁-C₆-alkylsulfonyl, C₁-C₆-alkyl-sulfinyl, C₃-C₆-cycloalkyl, C₁-C₆-alkoxy, C₁-C₆-haloalkoxy, C₁-C₆-alkoxy-carbonyl, C₁-C₆-alkylthio, C₁-C₆-alkylamino, di-C₁-C₆-alkylamino, C₁-C₆-alkylaminocarbonyl, di-C₁-C₆-alkylaminocarbonyl, C₁-C₆-alkylaminothio-carbonyl, di-C₁-C₆-alkylaminothiocarbonyl, C₂-C₆-alkenyl, C₂-C₆-alkenyloxy, C₃-C₆-cycloalkyl, C₃-C₆-cycloalkenyl, phenyl, phenoxy, phenylthio, benzyl, benzyloxy, 5- or 6-membered heterocyclyl, 5- or 6-membered heteroaryl, 5- or 6-membered heteroaryloxy or C(═NOR^{A})—R^{B};
      R^{A}, R^{B} are, independently, hydrogen or C₁-C₆-alkyl;
   R¹ is hydrogen, cyano, C₁-C₄-alkyl, C₁-C₄-haloalkyl, C₃-C₆-cycloalkyl, C₁-C₄-alkoxy or C₁-C₄-alkylthio;
   R² is phenyl, phenylcarbonyl, phenylsulfonyl, 5- or 6-membered heteroaryl, 5- or 6-membered heteroarylcarbonyl or 5- or 6-membered heteroarylsulfonyl, it being possible for the abovementioned cyclic groups to be unsubstituted or substituted by one, two or three radicals R^{a};
      C₁-C₁₀-alkyl, C₃-C₆-cycloalkyl, C₂-C₁₀-alkenyl, C₂-C₁₀-alkynyl, C₁-C₁₀-alkylcarbonyl, C₂-C₁₀-alkenylcarbonyl, C₃-C₁₀-alkynylcarbonyl, Cᵢ-C₁₀-alkylsulfonyl or C(═NOR^{a})—R^{b}, it being possible for the hydrocarbon radicals of these groups to be unsubstituted or substituted by one, two or three radicals R^{c}:
      R^{c} is, independently of one another, selected among cyano, nitro, amino, aminocarbonyl, aminothiocarbonyl, halogen, C₁-C₆-alkyl, C₁-C₆-haloalkyl, C₁-C₆-alkylsulfonyl, C₁-C₆-alkylsulfynyl, C₁-C₆-alkoxy, C₁-C₆-haloalkoxy, C₁-C₆-alkoxycarbonyl, C₁-C₆-alkylthio, C₁-C₆-alkylamino, di-C₁-C₆-alkylamino, C₁-C₆-alkylaminocarbonyl, di-C₁-C₆-alkylaminocarbonyl, C₁-C₆-alkylaminothiocarbonyl, di-C₁-C₆-alkylaminothiocarbonyl, C₂-C₆-alkenyl, C₂-C₆-alkenyloxy,
         C₃-C₆-cycloalkyl, C₃-C₆-cycloalkyloxy, 5- or 6-membered heterocyclyl, 5- or 6-membered heterocyclyloxy, benzyl, benzyloxy, phenyl, phenoxy, phenylthio, 5- or 6-membered heteroaryl, 5- or 6-membered heteroaryloxy and heteroarylthio, it being possible for the abovementioned cyclic groups to be partially or fully halogenated or to be substituted by one, two or three radicals R^{a}, and
R³ is hydrogen, C₁-C₆-alkyl, C₂-C₆-alkenyl, C₂-C₆-alkynyl, it being possible for the three last-mentioned groups to be unsubstituted or to have one, two or three radicals R^{c};
   and
   2) the following active ingredients: methyl (2-chloro-5-[1-(3-methylbenzyloxyimino)-ethyl]benzyl)carbamate, methyl (2-chloro-5-[1-(6-methylpyridin-2-ylmethoxyimino)-ethyl]benzyl)carbamate, methyl 2-(ortho-((2,5-dimethylphenyloxymethylene)phenyl)-3-methoxyacrylate, N-methyl-2-(2-(6-(3-chloro-2-methylphenoxy)-5-fluoropyrimidin-4-yloxy)phenyl)-2-methoxyiminoacetamide and methyl 3-methoxy-2-(2-(N-(4-methoxyphenyl)cyclopropanecarboximidoylsulfanylmethyl)phenyl)acrylate.

These active ingredients have been known as fungicides for some time. The preparation is also known from the prior art.

In one embodiment the compositions according to the invention comprise one or more strobilurins of the formula I as active ingredient b).

In another embodiment the compositions according to the invention comprise at least one strobilurin which is selected among methyl (2-chloro-5-[1-(3-methylbenzyloxyimino)ethyl]benzyl)carbamate, methyl (2-chloro-5-[1-(6-methylpyridin-2-ylmethoxyimino)ethyl]benzyl)carbamate, and methyl 2-(ortho-((2,5-dimethylphenyl-oxymethylene)phenyl)-3-methoxyacrylate.

In a preferred embodiment of the present invention, the strobilurins are compounds of the formula I in which Q is N(—OCH₃)—COOCH₃; these active ingredients are described in WO 93/15046 and WO 96/01256.

In another preferred embodiment of the present invention, the strobilurins are compounds of the formula I in which Q is C(═CH—OCH₃)—COOCH₃; these active ingredients are described in EP-A 178 826 and EP-A 278 595.

In a further preferred embodiment of the present invention, the strobilurins are compounds of the formula I in which Q is C(═N—OCH₃)—COOCH₃; these active ingredients are described in EP-A 253 213 and EP-A 254 426.

In a further preferred embodiment of the present invention, the strobilurins are compounds of the formula I in which Q is C(═N—OCH₃)—CONHCH₃; these active ingredients are described in EP-A 398 692, EP-A 477 631 and EP-A 628 540.

In further preferred embodiment of the present invention, the strobilurins are compounds of the formula I in which Q is C(═CH—CH₃)—COOCH₃; these active ingredients are described in EP-A 280 185 and EP-A 350 691.

In a further preferred embodiment of the present invention, the strobilurins are compounds of the formula I in which A is CH₂O—N═C(R¹)—B, where R¹ and B have the meanings given for formula I; these active ingredients are described in EP-A 460 575 and EP-A 463 488.

In a preferred embodiment of the present invention, the strobilurins are compounds of the formula I in which A is O—B, where R¹ and B have the meanings given for formula I; these active ingredients are described in EP-A 382 375 and EP-A 398 692.

In a preferred embodiment of the present invention, the strobilurins are compounds of the formula I where A is —CH₂O—N═C(R¹)—C(R²)═N—OR³, where R¹, R² and R³ have the meanings given for formula I; these active ingredients are described in WO 95/18789, WO 95/21153, WO 95/21154, WO 97/05103 and WO 97/06133.

Especially preferred are the strobilurins of the formula I in which

### Q is N(—OCH₃)—COOCH₃,

### A is CH₂—O— and

B is selected among 3-pyrazolyl or 1,2,4-triazol-3-yl, where B is bonded to one or two substitutents selected from the group consisting of
halogen, methyl, trifluoromethyl and
phenyl or pyridyl, especially 2-pyridyl, where phenyl and pyridyl can be substituted by 1 to 3 radicals R^{b}.

These active ingredients are described in particular by the formula II,

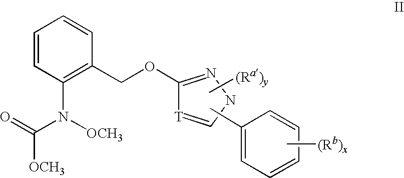

where T is a carbon or a nitrogen atom, R^{a′} is independently selected from among halogen, methyl and trifluoromethyl

y is zero, 1 or 2, R^{b} is as defined for formula I, x is zero, 1, 2, 3 or 4.

Especially preferred active ingredients of the formula II are those of the formula II′:

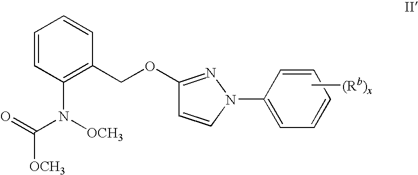

where R^{b} is as defined for formula I.

According to the present invention, the strobilurin is especially preferably selected among the substances which are listed in the tables 1 to 7 hereinbelow.

TABLE 1
II

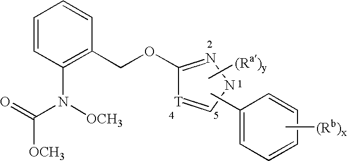

| | | | Position of the group | | |
|---|---|---|---|---|---|
| No. | T | (R^{a′})_{y} | phenyl-(R^{b})ₓ | (R^{b})ₓ | Reference |
| 11-1 | N | — | 1 | 2,4-Cl₂ | WO 96/01256 |
| 11-2 | N | — | 1 | 4-Cl | WO 96/01256 |
| 11-3 | CH | — | 1 | 2-Cl | WO 96/01256 |
| 11-4 | CH | — | 1 | 3-Cl | WO 96/01256 |
| 11-5 | CH | — | 1 | 4-Cl | WO 96/01256 |
| 11-6 | CH | — | 1 | 4-CH₃ | WO 96/01256 |
| 11-7 | CH | — | 1 | H | WO 96/01256 |
| 11-8 | CH | — | 1 | 3-CH₃ | WO 96/01256 |
| 11-9 | CH | 5-CH₃ | 1 | 3-CF₃ | WO 96/01256 |
| 11-10 | CH | 1-CH₃ | 5 | 3-CF₃ | WO 99/33812 |
| 11-11 | CH | 1-CH₃ | 5 | 4-Cl | WO 99/33812 |
| 11-12 | CH | 1-CH₃ | 5 | — | WO 99/33812 |

TABLE 2
III

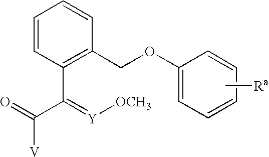

| No. | V | Y | Radical | Reference |
|---|---|---|---|---|
| III-1 | OCH₃ | N | 2-CH₃ | EP-A 253 213 |
| III-2 | OCH₃ | N | 2,5-(CH₃)₂ | EP-A 253 213 |
| III-3 | NHCH₃ | N | 2,5-(CH₃)₂ | EP-A 477 631 |
| III-4 | NHCH₃ | N | 2-Cl | EP-A 398 692 |
| III-5 | NHCH₃ | N | 2-CH₃ | EP-A 398 692 |
| III-6 | NHCH₃ | N | 2-CH₃, 4-OCF₃ | EP-A 628 540 |
| III-7 | NHCH₃ | N | 2-Cl, 4-OCF₃ | EP-A 628 540 |
| III-8 | NHCH₃ | N | 2-CH₃, | EP-A 11 18 609 |
| | | | 4-OCH(CH₃)—C(CH₃)═NOCH₃ | |
| III- | NHCH₃ | N | 2-Cl, | EP-A 11 18 609 |
| 9 | | | 4-OCH(CH₃)—C(CH₃)═NOCH₃ | |
| III- | NHCH₃ | N | 2-CH₃, 4- | EP-A 11 18 609 |
| 10 | | | OCH(CH₃)—C(CH₂CH₃)═NOCH₃ | |
| III- | OCH₃ | CH | 2,5-(CH₃)₂ | EP-A 226 917 |
| 11 | | | | |

TABLE 3
IV

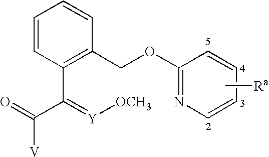

| No. | V | Y | T | R^{a} | Reference |
|---|---|---|---|---|---|
| IV-1 | OCH₃ | CH | N | 2-OCH₃, 4-CF₃ | WO 96/16047 |
| IV-2 | OCH₃ | CH | N | 2-OCH(CH₃)₂, 4-CF₃ | WO 96/16047 |
| IV-3 | OCH₃ | CH | CH | 2-CF₃ | EP-A 278 595 |
| IV-4 | OCH₃ | CH | CH | 4-CF₃ | EP-A 278 595 |
| IV-5 | NHCH₃ | N | CH | 2-Cl | EP-A 398 692 |
| IV-6 | NHCH₃ | N | CH | 2-CF₃ | EP-A 398 692 |
| IV-7 | NHCH₃ | N | CH | 2-CF₃, 4-Cl | EP-A 398 692 |
| IV-8 | NHCH₃ | N | CH | 2-Cl, 4-CF₃ | EP-A 398 692 |

TABLE 4
V

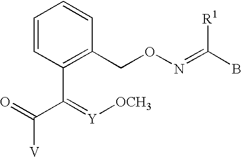

| No. | V | Y | R¹ | B | Reference |
|---|---|---|---|---|---|
| V-1 | OCH₃ | CH | CH₃ | (3-CF₃)C₅H₄ | EP-A 370 629 |
| V-2 | OCH₃ | CH | CH₃ | (3,5-Cl₂)C₆H₃ | EP-A 370 629 |
| V-3 | NHCH₃ | N | CH₃ | (3-CF₃)C₆H₄ | WO 92/13830 |
| V-4 | NHCH₃ | N | CH₃ | (3-OCF₃)C₆H₄ | WO 92/13830 |
| V-5 | OCH₃ | N | CH₃ | (3-OCF₃)C₆H₄ | EP-A 460 575 |
| V-6 | OCH₃ | N | CH₃ | (3-CF₃)C₆H₄ | EP-A 460 575 |
| V-7 | OCH₃ | N | CH₃ | (3,4-Cl₂)C₆H₃ | EP-A 460 575 |
| V-8 | OCH₃ | N | CH₃ | (3,5-Cl₂)C₆H₃ | EP-A 463 488 |
| V-9 | OCH₃ | CH | CH₃ | CH═CH-(4-Cl)C₆H₄ | EP-A 936 213 |

TABLE 5
VI

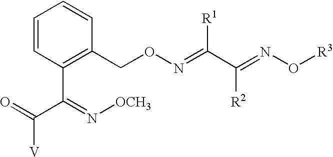

| No. | V | R¹ | R² | R³ | Reference |
|---|---|---|---|---|---|
| VI-1 | OCH₃ | CH₃ | CH₃ | CH₃ | WO 95/18789 |
| VI-2 | OCH₃ | CH₃ | CH(CH₃)₂ | CH₃ | WO 95/18789 |
| VI-3 | OCH₃ | CH₃ | CH₂CH₃ | CH₃ | WO 95/18789 |
| VI-4 | NHCH₃ | CH₃ | CH₃ | CH₃ | WO 95/18789 |
| VI-5 | NHCH₃ | CH₃ | 4-F-C₆H₄ | CH₃ | WO 95/18789 |
| VI-6 | NHCH₃ | CH₃ | 4-Cl-C₆H₄ | CH₃ | WO 95/18789 |
| VI-7 | NHCH₃ | CH₃ | 2,4-C₆H₃ | CH₃ | WO 95/18789 |
| VI-8 | NHCH₃ | Cl | 4-F-C₆H₄ | CH₃ | WO 98/38857 |
| VI-9 | NHCH₃ | Cl | 4-Cl-C₆H₄ | CH₂CH₃ | WO 98/38857 |
| VI-10 | NHCH₃ | CH₃ | CH₂C(═CH₂)CH₃ | CH₃ | WO 97/05103 |
| VI-11 | NHCH₃ | CH₃ | CH═C(CH₃)₂ | CH₃ | WO 97/05103 |
| VI-12 | NHCH₃ | CH₃ | CH═C(CH₃)₂ | CH₂CH₃ | WO 97/05103 |
| VI-13 | NHCH₃ | CH₃ | CH═C(CH₃)CH₂CH₃ | CH₃ | WO 97/05103 |
| VI-14 | NHCH₃ | CH₃ | O-CH(CH₃)₂ | CH₃ | WO 97/06133 |
| VI-15 | NHCH₃ | CH₃ | O-CH₂CH(CH₃)₂ | CH₃ | WO 97/06133 |
| VI-16 | NHCH₃ | CH₃ | C(CH₃)═NOCH₃ | CH₃ | WO 97/15552 |

TABLE 6
VII

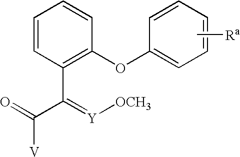

| No. | V | Y | R^{a} | Reference |
|---|---|---|---|---|
| VII-1 | NHCH₃ | N | H | EP-A 398 692 |
| VII-2 | NHCH₃ | N | 3-CH₃ | EP-A 398 692 |
| VII-3 | NHCH₃ | N | 2-NO₂ | EP-A 398 692 |
| VII-4 | NHCH₃ | N | 4-NO₂ | EP-A 398 692 |
| VII-5 | NHCH₃ | N | 4-Cl | EP-A 398 692 |
| VII-6 | NHCH₃ | N | 4-Br | EP-A 398 692 |

TABLE 7
VIII

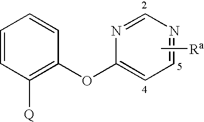

| No. | Q | R^{a} | Reference |
|---|---|---|---|
| VIII-1 | C(═CH—OCH₃)COOCH₃ | 5-O-(2-CN—C₆H₄) | EP-A 382 375 |
| VIII-2 | C(═CH—OCH₃)COOCH₃ | 5-O-(2-Cl—C₆H₄) | EP-A 382 375 |
| VIII-3 | C(═CH—OCH₃)COOCH₃ | 5-O-(2-CH₃—C₆H₄) | EP-A 382 375 |
| VIII-4 | C(═N—OCH₃)CONHCH₃ | 5-O-(2-Cl—C₆H₄) | GB-A 2253624 |
| VIII-5 | C(═N—OCH₃)CONHCH₃ | 5-O-(2,4-Cl₂—C₆H₃) | GB-A 2253624 |
| VIII-6 | C(═N—OCH₃)CONHCH₃₃ | 5-O-(2-CH₃—C₆H₄) | GB-A 2253624 |
| VIII-7 | C(═N—OCH₃)CONHCH₃ | 5-O-(2-CH₃, 3-Cl—C₆H₃) | GB-A 2253624 |
| VIII-8 | C(═N—OCH₃)CONHCH₃ | 4-F, 5-O-(2-CH₃—C₆H₄) | WO 98/21189 |
| VIII-9 | C(═N—OCH₃)CONHCH₃ | 4-F, 5-O-(2-Cl—C₆H₄) | WO 98/21189 |
| VIII-10 | C(═N—OCH₃)CONHCH₃ | 4-F, 5-O-(2-CH₃, 3-Cl—C₆H₃) | WO 98/21189 |
| VIII-11 | 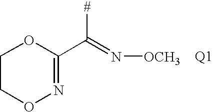 | 4-F, 5-O-(2-Cl—C₆H₄) | WO 97/27189 |
| VIII-12 | 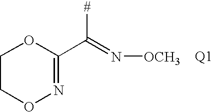 | 4-F, 5-O-(2-CH₃, 3-Cl—C₆H₃) | WO 97/27189 |
| VIII-13 | 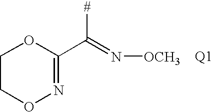 | 4-F, 5-O-(2,4-Cl₂—C₆H₃) | WO 97/27189 |

Especially preferred are the strobilurins: compound II-5 (pyraclostrobin), III-1 (kresoxim-methyl), III-3 (dimoxystrobin), III-11 (ZJ 0712), IV-3 (picoxystrobin), V-6 (trifloxystrobin), V-9 (enestroburin), VI-16 (orysastrobin), VII-1 (metominostrobin), VIII-1 (azoxystrobin), and VIII-11 (fluoxastrobin). Very especially preferred is pyraclostrobin (compound II-5), kresoxim-methyl (compound III-1) or azoxystrobin (compound VIII-1), pyraclostrobin is the most preferred.

The compositions according to the invention may, instead or together with the active ingredient from the group of the strobilurins, comprise one or more plant protectants other than strobilurins. Those which may be mentioned are fungicidal active ingredients which are in particular selected among carboxamides, azoles, in particular conazoles, nitrogen-comprising heterocyclic compounds, carbamates, dithiocarbamates and other fungicides selected from among dodine, iminoctadine, guazatine, kasugamycin, polyoxin, streptomycin, validamycin A, fentin salts, isoprothiolan, dithianon, edifenphos, fosetyl, fosetyl-aluminum, iprobenfos, pyrazophos, tolclofos-methyl, phosphoric acid and its salts, thiophanate-methyl, chlorothalonil, dichlofluanid, tolylfluanid, flusulfamid, phthalide, hexachlorobenzene, pencycuron, quintozene, binapacryl, dinocap, dinobuton, Bordeaux mixtures, copper azetate, copper hydroxide, copper oxychloride, basic copper sulfates, sulfur, spiroxamin, cyflufenamid, cymoxanil and metrafenon.

Examples of suitable fungicides are the fungicidally active ingredients specified in the list which follows:

### Carboxamides

carboxanilides: benalaxyl, benalaxyl-M, benodanil, bixafen, boscalid, carboxin, mepronil, fenfuram, fenhexamid, flutolanil, furametpyr, metalaxyl, ofurace, oxadixyl, oxycarboxin, penthiopyrad, thifluzamid, tiadinil, 2-amino-4-methyl-thiazole-5-carboxanilide, 2-chloro-N-(1,1,3-trimethylindan-4-yl)nicotinamide, N-(4′-bromobiphenyl-2-yl)-4-difluoromethyl-2-methylthiazole-5-carboxamide, N-(4′-trifluoromethylbiphenyl-2-yl)-4-difluoromethyl-2-methylthiazole-5-carboxamide, N-(4′-chloro-3′-fluorobiphenyl-2-yl)-4-difluoromethyl-2-methylthiazole-5-carboxamide, N-(3′,4′-dichloro-4-fluorobiphenyl-2-yl)-3-difluoromethyl-1-methylpyrazol-4-ylcarboxamide, N-(3′,4′-dichloro-5-fluorobiphenyl-2-yl)-3-difluoromethyl-1-methyl-1H-pyrazole-4-carboxamide, N-(2-(1,3-dimethylbutyl)phenyl)-1,3,3-trimethyl-5-fluoro-1H-pyrazole-4-carboxamide, N-(4′-chloro-3′,5′-difluorobiphenyl-2-yl)-3-difluoromethyl-1-methyl-1H-pyrazole-4-carboxamide, N-(4′-chloro-3′,5-difluorobiphenyl-2-yl)-3-trifluoromethyl-1-methyl-1H-pyrazole-4-carboxamide, N-(3′,4′-dichloro-5-fluorobiphenyl-2-yl)-3-trifluoromethyl-1-methyl-1H-pyrazole-4-carboxamide, N-(3′,5-difluoro-4′-methylbiphenyl-2-yl)-3-difluoromethyl-1-methyl-1H-pyrazole-4-carboxamide, N-(3′,5-difluoro-4′-methylbiphenyl-2-yl)-3-trifluoromethyl-1-methyl-1H-pyrazole-4-carboxamide, N-(2-bicyclopropyl-2-ylphenyl)-3-difluoromethyl-1-methyl-1H-pyrazole-4-carboxamide, N-(cis-2-bicyclopropyl-2-ylphenyl)-3-difluoromethyl-1-methyl-1H-pyrazole-4-carboxamide, N-(trans-2-bicyclopropyl-2-ylphenyl)-3-difluoromethyl-1-methyl-1H-pyrazole-4-carboxamide, N-(2-cyanophenyl)-3,4-dichloroisothiazole-5-carboxamide;
carboxylic acid morpholides: dimethomorph, flumorph;
benzamides: flumetover, fluopicolid (picobenzamid), fluopyram, zoxamid, N-(3-ethyl-3,5,5-trimethylcyclohexyl)-3-formylamino-2-hydroxybenzamide;
other carboxamides: carpropamid, diclocymet, mandipropamid, oxytetracyclin, silthiofam, N-(6-methoxypyridin-3-yl)cyclopropanecarboxamide, N-(2-(4-[3-(4-chlorophenyl)prop-2-inyloxy]-3-methoxyphenyl)ethyl)-2-methanesulfonylamino-3-methylbutyramide, N-(2-(4-[3-(4-chlorophenyl)prop-2-ynyloxy]-3-methoxy-phenyl)ethyl)-2-ethanesulfonylamino-3-methylbutyramide;

### Azoles

triazoles: azaconazole, bitertanol, bromuconazole, cyproconazole, difenoconazole, diniconazole, diniconazole-M, enilconazole, epoxiconazole, fenbuconazole, flusilazole, fluquinconazole, flutriafol, hexaconazole, imibenconazole, ipconazole, metconazole, myclobutanil, oxpoconazole, paclobutrazol, penconazole, propiconazole, prothioconazole, simeconazole, tebuconazole, tetraconazole, triadimenol, triadimefon, triticonazole, uniconazole, 1-(4-chlorophenyl)-2-([1,2,4]triazol-1-yl)cycloheptanol;
imidazoles: cyazofamid, imazalil, imazalil-sulfate, pefurazoate, prochloraz, triflumizole;
benzimidazoles: benomyl, carbendazim, fuberidazole, thiabendazole;
others: ethaboxam, etridiazole, hymexazole;

Of the azoles detailed here, the compounds listed among the triazoles and imidazoles are also referred to as conazoles or conazole fungicides.

### Nitrogen-Comprising Heterocyclic Compounds

pyridines: fluazinam, pyrifenox, 3-[5-(4-chlorophenyl)-2,3-dimethylisoxazolidin-3-yl]pyridine, 2,3,5,6-tetrachloro-4-methanesulfonylpyridine, 3,4,5-trichloropyridine-2,6-dicarbonitrile, N-(1-(5-bromo-3-chloropyridin-2-yl)ethyl)-2,4-dichloro-nicotinamide, N-((5-bromo-3-chloropyridin-2-yl)methyl)-2,4-dichloronicotinamide;
pyrimidines: bupirimate, cyprodinil, diflumetorim, ferimzone, fenarimol, mepanipyrim, nitrapyrin, nuarimol, pyrimethanil;
piperazines: triforine;
pyrroles: fludioxonil, fenpiclonil;
morpholines: aldimorph, dodemorph, fenpropimorph, tridemorph;
dicarboximides: iprodione, procymidone, vinclozolin;
other nitrogen-comprising heterocyclic compounds: acibenzolar-S-methyl, anilazin, captan, captafol, dazomet, diclomezine, fenoxanil, folpet, fenpropidin, famoxadone, fenamidone, octhilinone, probenazole, proquinazid, pyroquilon, quinoxyfen, tricyclazole, azolopyrimidines of the formula IX defined hereinbelow, for example 5-chloro-7-(4-methylpiperidin-1-yl)-6-(2,4,6-trifluorophenyl)-[1,2,4]triazolo[1,5-a]pyrimidine, 6-(3,4-dichlorophenyl)-5-methyl-[1,2,4]triazolo[1,5-a]pyrimidin-7-ylamine, 6-(4-tert-butylphenyl)-5-methyl-[1,2,4]triazolo[1,5-a]pyrimidin-7-ylamine, 5-methyl-6-(3,5,5-trimethylhexyl)-[1,2,4]triazolo[1,5-a]pyrimidin-7-ylamine, 5-methyl-6-octyl-[1,2,4]triazolo[1,5-a]pyrimidin-7-ylamine, 5-ethyl-6-octyl-[1,2,4]-triazolo[1,5-a]pyrimidin-2,7-diamine, 6-ethyl-5-octyl-[1,2,4]triazolo[1,5-a]pyrimidin-7-ylamine, 5-ethyl-6-octyl-[1,2,4]triazolo[1,5-a]pyrimidin-7-ylamine, 5-ethyl-6-(3,5,5-trimethylhexyl)-[1,2,4]triazolo[1,5-a]pyrimidin-7-ylamine, 6-octyl-5-propyl-[1,2,4]triazolo[1,5-a]pyrimidin-7-ylamine, 5-methoxymethyl-6-octyl-[1,2,4]triazolo[1,5-a]pyrimidin-7-ylamine, 6-octyl-5-trifluoromethyl-[1,2,4]triazolo[1,5-a]pyrimidin-7-ylamine, 5-trifluoromethyl-6-(3,5,5-trimethylhexyl)-[1,2,4]triazolo[1,5-a]pyrimidin-7-ylamine, 2-butoxy-6-iodo-3-propylchromen-4-one, N-dimethyl-3-(3-bromo-6-fluoro-2-methylindole-1-sulfonyl)-[1,2,4]triazole-1-sulfonamide;

### Carbamates and Dithiocarbamates

dithiocarbamates: ferbam, mancozeb, maneb, metiram, metiram, propineb, thiram, zineb, ziram;
carbamates: diethofencarb, flubenthiavalicarb, iprovalicarb, propamocarb, methyl 3-(4-chlorophenyl)-3-(2-isopropoxycarbonylamino-3-methylbutyrylamino)-propionate, 4-fluorophenyl N-(1-(1-(4-cyanophenyl)ethanesulfonyl)but-2-yl)carbamate;

Other Fungicides
guanidines: dodine, iminoctadine, guazatine;
antibiotics: kasugamycin, polyoxins, streptomycin, validamycin A;
organometallic compounds: fentin salts;
sulfur-comprising heterocyclyl compounds: isoprothiolane, dithianon;
organophosphorus compounds: edifenphos, fosetyl, fosetyl-aluminum, iprobenfos, pyrazophos, tolclofos-methyl, phosphorous acid and its salts;
organochlorine compounds: thiophanate-methyl, chlorthalonil, dichlofluanid, tolylfluanid, flusulfamid, phthalide, hexachlorbenzene, pencycuron, quintozene;
nitrophenyl derivatives: binapacryl, dinocap, dinobuton;
inorganic active ingredients: Bordeaux mixture, copper acetate, copper hydroxide, copper oxychloride, basic copper sulfate, sulfur;
others: spiroxamin, cyflufenamid, cymoxanil, metrafenon, biphenyl, bronopol, diphenylamine, mildiomycin, oxine-copper, prohexadione-calcium, tolylfluanid, N-(cyclopropylmethoxyimino-(6-difluoromethoxy-2,3-difluorophenyl)methyl)-2-phenylacetamide, N′-(4-(4-chloro-3-trifluoromethylphenoxy)-2,5-dimethylphenyl)-N-ethyl-N-methylformamidine, N′-(4-(4-fluoro-3-trifluoromethylphenoxy)-2,5-dimethylphenyl)-N-ethyl-N-methylformamidine, N′-(2-methyl-5-trifluoromethyl-4-(3-trimethylsilanylpropoxy)phenyl)-N-ethyl-N-methylformamidine, N′-(5-difluoromethyl-2-methyl-4-(3-trimethylsilanylpropoxy)phenyl)-N-ethyl-N-methyl formamidine.

Especially mixing partners for strobilurins are fungicides which are selected among nitrogen-containing heterocyclic compounds, carbamates, dithiocarbamates and morpholins, in particular selected among diethofencarb, flubenthiavalicarb, iprovalicarb, propamocarb, methyl 3-(4-chlorophenyl)-3-(2-isopropoxycarbonylamino-3-methyl-butyrylamino)propionate, 4-fluorophenyl N-(1-(1-(4-cyanophenyl)ethanesulfonyl)but-2-yl)carbamate, ferbam, mancozeb, maneb, metiram, metam, propineb, thiram, zineb, ziram, aldimorph, dodemorph, fenpropimorph, tridemorph and folpet, specifically metiram, fenpropimorph and folpet.

In a preferred embodiment of the compositions according to the invention, the active ingredient b) is a strobilurin, in particular a strobilurin specified as being preferred, specifically pyraclostrobin, or a mixture of one or more strobilurins, and one or more further fungicides as defined above. Very specially preferred are mixtures in which the strobilurin is a strobilurin which has been specified as being preferred, and specifically pyraclostrobin.

In an especially preferred embodiment of the present invention, the active ingredient present in the compositions comprises a strobilurin which is selected from among pyraclostrobin, kresoxim-methyl, dimoxystrobin, picoxystrobin, trifloxystrobin, enestroburin, orysastrobin, metominostrobin, azoxystrobin and fluoxastrobin, which is present in the composition optionally together with one or two further fungicides as defined above, with pyraclostrobin being the preferred strobilurin. Examples of combinations of a strobilurin and a further fungicide comprise, but are not limited to, pyraclostrobin and metiram, azoxystrobin and metiram, kresoxim-methyl and metiram, pyraclostrobin and folpet, azoxystrobin and folpet, kresoxim-methyl and folpet.

In another preferred embodiment of the invention, the plant protectant present in the composition comprises at least one fungicidal active ingredient from the group of the conazole fungicides, in particular a conazole fungicide selected from the group of the triazoles, specifically epoxyconazole. In this embodiment, the composition may comprise the conazole fungicide as the only active ingredient or in combination with a further active ingredient, for example an insecticidal or fungicidal active ingredient. Specifically, the active ingredient combination is a combination of at least one conazole fungicide, specifically epoxyconazole, with at least one strobilurin, in particular pyraclostrobin, and, if appropriate, a further active ingredient, for example fenpropidin; a combination of two different conazole fungicides, specifically epoxiconazole with at least one further conazole fungicide other than epoxiconazole, in particular with a conazole fungicide selected from among prochloraz, cyproconazole, fluquinconazole, hexaconazole, metconazole, penconazole, propiconazole, prothioconazole, tebuconazole and triticonazole and specifically metconazole, fluquinconazole and prothioconazole.

In another preferred embodiment of the invention, the plant protectant present in the composition comprises at least one fungicidal active ingredient from the group of the azolopyrimidines of the formula IX

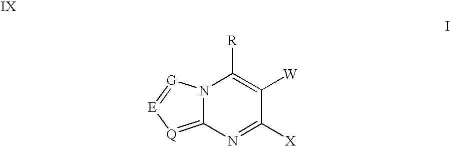

in which the substituents have the following meaning:

G, E, Q
a) G is N; E is C—W² and Q is N or C—W³;
b) G is C—W¹; E is C—W² and Q is N; or
c) G is C—W¹; E is N and Q is C—W³;
W¹, W², W³ each independently of one another are hydrogen, halogen, cyano, nitro, C₁-C₄-alkyl, C₂-C₆-alkenyl, C₂-C₆-alkynyl, C₁-C₄-haloalkyl, hydroxy-C₁-C₄-alkyl, C₁-C₄-alkoxy-C₁-C₄-alkyl, C₂-C₆-haloalkenyl, C₂-C₆-haloalkynyl, C₃-C₆-cycloalkyl, C₃-C₆-halocycloalkyl, C₁-C₄-alkoxy, C₁-C₄-haloalkoxy, C₁-C₄-alkylthio, C₁-C₄-alkylsulfinyl or C₁-C₄-alkylsulfonyl, formyl, thiocarbamoyl, C₁-C₄-alkylcarbonyl, C₁-C₄-alkoxycarbonyl, C₁-C₄-alkylaminocarbonyl, aminocarbonyl, di-(C₁-C₄-alkyl)-aminocarbonyl, C₁-C₄-alkoximinocarbonyl, hydroximinoalkyl, CR¹⁰R¹¹OR¹², C(R¹³)═NR¹⁴;
   R¹⁰, R¹¹, R¹² independently of one another are hydrogen, C₁-C₈-alkyl, C₃-C₆-cycloalkyl, C₁-C₈-alkoxy-C₁-C₈-alkyl, C₂-C₈-alkenyl, C₂-C₈-alkynyl, benzyl;
   R¹¹ and R¹² may together be oxy-C₁-C₅-alkylenoxy, where the carbon chain may be substituted by one to three groups selected from among methyl, ethyl, hydroxy, methoxy, ethoxy, hydroxymethyl, methoxymethyl, ethoxymethyl;
   R¹³ is hydrogen or C₁-C₈-alkyl;
   R¹⁴ is C₁-C₈-alkyl, C₃-C₆-cycloalkyl, phenyl, phenylamino, it being possible for the phenyl groups to be substituted by one to five groups R^{b};
R is NR¹R², or C₁-C₁₀-alkyl, C₁-C₁₀-haloalkyl, C₂-C₁₀-alkenyl, C₂-C₁₀-haloalkenyl, C₂-C₁₀-alkynyl, C₂-C₁₀-haloalkynyl, C₃-C₁₂-cycloalkenyl, C₃-C₁₂-halocycloalkenyl, phenyl, halophenyl, naphthyl, halonaphthyl or a five-, six-, seven-, eight-, nine- or ten-membered saturated, partially unsaturated or aromatic heterocycle which is bonded by a carbon and which can be partially or fully halogenated, comprising one, two, three or four hetero atoms selected from the group consisting of oxygen, nitrogen and sulfur; where R may comprise one, two, three or four identical or different groups R^{a}, independently of one another are selected from among:
   R^{a} is cyano, nitro, hydroxy, carboxyl, C₁-C₆-alkyl, C₂-C₆-alkynyl, C₃-C₆-cyclo-alkyl, C₃-C₈-cycloalkenyl, C₁-C₆-alkoxy, C₂-C₆-alkenyloxy, C₃-C₆-alkynyloxy, C₃-C₆-cycloalkoxy, C₃-C₆-cycloalkenyloxy, C(O)R^{π}, C(O)OR^{π}, C(S)OR^{π}, C(O)SR^{π}, C(S)SR^{π}, OC(O)OR^{π}, C₁-C₆-alkylthio, amino, C₁-C₆-alkylamino, di-C₁-C₆-alkylamino, aminocarbonyl, C(O)NHR^{π}, C(O)NR^{π}₂, C₁-C₆-alkylene, oxy-C₁-C₄-alkylene, oxy-C₁-C₃-alkylenoxy, where divalent groups can be bonded to the same atom or to adjacent atoms, or is phenyl, naphthyl, a five-, six-, seven-, eight-, nine- or ten-membered saturated, partially unsaturated or aromatic heterocycle comprising one, two, three or four hetero atoms selected from the group consisting of O, N and S;
      R^{π} is C₁-C₈-alkyl, C₃-C₈-alkenyl, C₃-C₈-alkynyl, phenyl, naphthyl, five-, six-, seven-, eight-, nine- or ten-membered saturated, partially unsaturated or aromatic heterocycle comprising one, two, three or four hetero atoms selected from the group consisting of O, N and S, or is C₃-C₆-cycloalkyl or C₃-C₆-cycloalkenyl, which groups R^{π} may be partially or fully halogenated;
   it being possible for the aliphatic, alicyclic or aromatic groups in the abovementioned groups R^{a} and R^{π}, in turn, to bear one, two or three groups R^{b}:
   R^{b} is cyano, nitro, hydroxy, mercapto, amino, carboxyl, alkyl, alkenyl, alkoxy, alkenyloxy, alkynyloxy, alkylthio, alkylamino, dialkylamino, formyl, alkylcarbonyl, alkylsulfonyl, alkylsulfoxyl, alkoxycarbonyl, alkylcarbonyloxy, alkoxycarbonyloxy, aminocarbonyl, aminothiocarbonyl, alkylaminocarbonyl, dialkylaminocarbonyl, alkyl-aminothiocarbonyl, dialkylaminothiocarbonyl, where the alkyl groups in these radicals comprise 1 to 6 carbon atoms and the abovementioned alkenyl or alkynyl groups in these radicals comprise 2 to 8 carbon atoms; cycloalkyl, cycloalkoxy, heterocyclyl, heterocyclyloxy, where the cyclic systems comprise 3 to 10 ring members; aryl, aryloxy, arylthio, aryl-C₁-C₆-alkoxy, aryl-C₁-C₆-alkyl, hetaryl, hetaryloxy, hetarylthio, where the aryl radicals preferably comprise 6 to 10 ring members, the hetaryl radicals 5 or 6 ring members, it being possible for the cyclic systems to be partially or fully halogenated and/or to be replaced by alkyl or haloalkyl groups;
R¹, R² independently of one another are hydrogen, C₁-C₁₂-alkyl, C₂-C₁₂-alkenyl, C₂-C₁₂-alkynyl, C₃-C₈-cycloalkyl, C₃-C₆-cycloalkenyl, C₁-C₈-alkoxy, C₂-C₈-alkenyloxy, C₂-C₈-alkynyloxy, C₃-Cₐ-cycloalkoxy, NH₂, C₁-C₈-alkylamino, di-C₁-C₈-alkylamino, phenyl, naphthyl or a five- or six-membered saturated, partially unsaturated or aromatic heterocycle comprising one, two, three or four hetero atoms selected from the group consisting of O, N and S, or
   Z—Y—(CR⁷R⁸)ₚ—(CR⁵R⁶)_{q}—CR³R⁴—#, where # is the linkage site with the nitrogen atom and:
   R³, R⁴, R⁵, R⁶, R⁷, R⁸ independently of one another are hydrogen, halogen, C₁-C₈-alkyl, C₁-C₈-haloalkyl, C₂-C₈-alkenyl, C₂-C₈-haloalkenyl, C₂-C₈-alkynyl, C₂-C₈-haloalkynyl, C₃-C₆-cycloalkyl, C₃-C₆-halocycloalkyl, C₃-C₆-cycloalkenyl, C₃-C₆-halocycloalkenyl, phenyl, naphthyl or a five- or six-membered saturated, partially unsaturated or aromatic heterocycle comprising one, two, three or four hetero atoms selected from the group consisting of O, N and S, which cyclic groups can be partially or fully halogenated and/or substituted by one or more groups R^{π}, R⁵ may also with R³ or R⁷ together with the atoms to which these radicals are bonded form a five-, six-, seven-, eight-, nine- or ten-membered saturated or partially unsaturated ring which, besides carbon atoms, may comprise one, two or three hetero atoms selected from the group consisting of O, N and S as ring member and/or which can bear one or more substituents R^{a};
   R³ with R⁴, R⁵ with R⁶, R⁷ with R⁸ in each case together may also be oxygen in order to form carbonyl groups or, in order to form spiro groups, together form a C₂-C₅-alkylene or alkenylene, alkynylene chain which can be interrupted by one, two or three hetero atoms selected from the group consisting of O, N and S;
   R¹ and R³ jointly together with the nitrogen atom to which they are bonded may form a five-, six-, seven-, eight-, nine- or ten-membered saturated or partially unsaturated heterocycle which, besides carbon atoms, may comprise one, two or three further hetero atoms selected from the group consisting of O, N and S as ring member;
   R³, R⁴, R⁵, R⁶, R⁷, R⁸ independently of one another can be partially or fully halogenated;
   R¹ to R⁸ in each case independently can bear one, two, three or four identical or different groups R^{a};
   Y is oxygen or sulfur;
   Z is hydrogen, carboxyl, formyl, C₁-C₈-alkyl, C₁-C₈-haloalkyl, C₂-C₈-alkenyl, C₂-C₈-haloalkenyl, C₂-C₈-alkynyl, C₂-C₈-haloalkynyl, C₃-C₆-cycloalkyl, C₃-C₈-cycloalkenyl, C(O)R^{π}, C(O)OR^{π}, C(S)OR^{π}, C(O)SR^{π}, C(S)SR^{π}, C(NR^{A})SR^{π}, C(S)R^{π}, C(NR^{π})NR^{A}R^{B}, C(NR^{π})R^{A}, C(NR^{π})OR^{A}, C(O)NR^{A}R^{B}, C(S)NR^{A}R^{B}, C₁-C₈-alkylsulfinyl, C₁-C₈-alkylthio, C₁-C₈-alkylsulfonyl, C(O)—C₁-C₄-alkylene-NR^{A}C(NR^{π})NR^{A}R^{B}, C(S)—C₁-C₄-alkylene-NR^{A}C(NR^{π})NR^{A}R^{B}, C(NR^{π})—C₁-C₄-alkylene-NR^{A}C(NR^{π})NR^{A}R^{B}, phenyl, naphthyl, five-, six-, seven-, eight-, nine- or ten-membered saturated, or partially unsaturated or aromatic heterocycle comprising one, two, three or four hetero atoms selected from the group consisting of O. N and S, which heterocycle is bonded directly or via a carbonyl, thiocarbonyl, C₁-C₄-alkylcarbonyl or C₁-C₄-alkylthiocarbonyl group; where in group Z the carbon chains can be substituted by one or more groups R^{b};
      R^{A}, R^{B} independently of one another are hydrogen, C₂-alkenyl, C₂-alkynyl or one of the groups mentioned in R^{π}; where R^{A} and R^{B} together with the nitrogen atom to which they are bonded, or R^{A} and R^{π} together with the carbon and hetero atoms via which they are bonded, can also form a three- to ten-membered saturated, partially unsaturated or aromatic mono- or bicyclic ring which, besides carbon atoms, can comprise one, two or three further hetero atoms selected from the group consisting of O, N and S as ring member, one or more oxo groups and/or one or more substituents R^{b};
      or
      Z can also with R⁶ or R⁸ form a five- or six-membered saturated or partially unsaturated ring which, besides carbon atoms and Y, can comprise one or two further hetero atoms selected from the group consisting of N and S as ring member and/or can bear one or more substituents R^{a} as defined hereinbelow;
      the Z group can be partially or fully halogenated and/or bear one, two or three groups R^{b};
   R¹ and R² can also, together with the nitrogen atom to which they are bonded, form a five-, six-, seven-, eight-, nine- or ten-membered saturated, partially unsaturated or aromatic mono- or bicyclic heterocycle which can be partially or fully halogenated and which, besides carbon atoms, can comprise one, two or three further hetero atoms selected from the group consisting of O, N and S as ring member and which can bear one, two or three substituents selected from among R^{a}, Z—Y-# and Z—Y—(CR⁶R⁶)_{q}—CR³R⁴—#, where # is the linkage site with the heterocycle;
   p is zero, 1, 2, 3, 4, or 5;
   q is zero or 1;
W is phenyl or five- or six-membered heteroaryl which, besides carbon atoms, contains one, two or three further heteroatoms selected from the group consisting of O, N and S as ring member, where the ring systems, besides groups Lₘ, bear at least one substituent P¹,
   P¹ is Y¹-Y²-T;
      Y¹ is CR^{A}R^{B}, C(=T²)O, C(=T²)NR^{A}, O, OC(=T²), NR^{A} or S(O)ᵣ;
      Y² is C₁-C₈-alkylene, C₂-C₈-alkenylene, C₂-C₈-alkynylene, where Y² can be interrupted by one, two or three hetero atoms selected from the group consisting of NR^{A}, O, S(O)ᵣ;
      r is 0, 1 or 2;
      T is YR, YR^{A}, NR^{A}R^{B}, YNR^{A}R^{B}, C(NOR^{A})R^{B}, S(O)ᵣR^{A}, N(R^{A})-T¹-C(=T²)-T³, T¹-C(=T²)-[(Y²)_{q}—C(=T²)]ₚ-T³, T¹-C(=T²)-[Y²-T¹-C(=T²)]ₚ-T³, T¹-C(=T²)-[T¹-Y²—C(=T²)]ₚ-T³ or T¹-C(=T²)-[NR^{A}—(NR^{B})_{q}—C(=T²)]ₚ-T³;
         T¹ is a direct bond, O, S, NR^{A};
         T² is Y, NR^{A};
         T³ is R, R^{B}, R^{π}, YR^{B}, NR^{A}R^{B};
   where the carbon atoms in group P¹ can be partially or fully halogenated and/or substituted by one or more groups R^{b};
   L is halogen, hydroxy, cyanato (OCN), cyano, nitro, C₁-C₈-alkyl, C₁-C₈-halo-alkyl, C₂-C₁₀-alkenyl, C₂-C₁₀-haloalkenyl, C₂-C₁₀-alkynyl, C₃-C₆-cycloalkyl, C₃-C₆-halocycloalkyl, C₃-C₆-cycloalkenyl, C₁-C₈-alkoxy, C₁-C₈-haloalkoxy, C₂-C₁₀-alkenyloxy, C₂-C₁₀-alkynyloxy, C₃-C₆-cycloalkyloxy, C₃-C₆-cyclo-alkenyloxy, amino, C₁-C₄-alkylamino, di-(C₁-C₄)-alkylamino, C₁-C₄-alkylcarbonylamino, C(O)—R^{Φ}, C(S)—R^{Φ}, S(O)ᵣ—R^{Φ}); C₁-C₈-alkoxyimino-(C₁-C₈)-alkyl, C₂-C₁₀-alkenyloxyimino-(C₁-C₈)-alkyl, C₂-C₁₀-alkynyloxyimino-(C₁-C₈)-alkyl, C₂-C₁₀-alkinylcarbonyl, C₃-C₈-cycloalkylcarbonyl, or a five-, six-, seven-, eight-, nine- or ten-membered saturated, partially unsaturated or aromatic heterocycle comprising one, two, three of four hetero atoms selected from the group consisting of O, N and S;
      R^{Φ} is hydrogen, C₁-C₄-alkyl, C₁-C₂-haloalkyl, C₁-C₄-alkoxy, C₂-C₄-alkenyl-oxy, C₂-C₄-alkynyloxy, amino, C₁-C₄-alkylamino, di-C₁-C₄-alkylamino; where the groups R^{Φ} can be substituted by one, two or three identical or different groups R^{b}, as defined hereinabove;
   m is zero, 1, 2, 3, 4 or 5;
X is halogen, cyano, C₁-C₄-alkyl, C₁-C₄-haloalkyl, C₁-C₄-alkoxy or C₁-C₄-haloalkoxy, amino, C₁-C₄-alkylamino or di-C₁-C₄-alkylamino, in particular halogen;
   and agriculturally acceptable salts thereof.

Preferred azolopyrimidines are those in which G and Q are N and E is CH, and X is halogen, specifically chlorine. Examples of preferred compounds of the formula IX are 5-chloro-7-(4-methylpiperidin-1-yl)-6-(2,4,6-trifluorophenyl)[1,2,4]triazolo-[1,5-a]pyrimidine, 6-(3,4-dichlorophenyl)-5-methyl-[1,2,4]triazolo[1,5-a]pyrimidin-7-ylamine, 6-(4-tert-butylphenyl)-5-methyl-[1,2,4]triazolo[1,5-a]pyrimidin-7-ylamine, 5-methyl-6-(3,5,5-trimethylhexyl)[1,2,4]-triazolo[1,5-a]pyrimidin-7-ylamine, 5-methyl-6-octyl-[1,2,4]triazolo[1,5-a]pyrimidin-7-ylamine, 5-ethyl-6-octyl-[1,2,4]triazolo-[1,5-a]pyrimidine-2,7-diamine, 6-ethyl-5-octyl-[1,2,4]triazolo[1,5-a]pyrimidin-7-ylamine, 5-ethyl-6-octyl-[1,2,4]triazolo[1,5-a]pyrimidin-7-ylamine, 5-ethyl-6-(3,5,5-trimethyl-hexyl)-[1,2,4]triazolo[1,5-a]pyrimidin-7-ylamine, 6-octyl-5-propyl-[1,2,4]triazolo[1,5-a]pyrimidin-7-ylamine, 5-methoxymethyl-6-octyl-[1,2,4]triazolo[1,5-a]pyrimidin-7-ylamine, 6-Octyl-5-trifluormethyl-[1,2,4]triazolo-[1,5-a]pyrimidin-7-ylamine, 5-trifluoromethyl-6-(3,5,5-trimethylhexyl)-[1,2,4]triazolo-[1,5-a]pyrimidin-7-ylamine and the agriculturally acceptable salts thereof.

In this embodiment, the composition may, besides the azolopyrimidine of formula IX, additionally comprise one or more further plant protectants, in particular a fungicide. The following list of fungicides together with which the azolopyrimidines IX can be used is intended to illustrate, but not to limit, the possible combinations:

Strobilurins: for example azoxystrobin, dimoxystrobin, enestroburin, fluoxastrobin, kresoxim-methyl, metominostrobin, picoxystrobin, pyraclostrobin, trifloxystrobin, orysastrobin, methyl (2-chloro-5-[1-(3-methylbenzyloxyimino)ethyl]benzyl)carbamate, methyl (2-chloro-5-[1-(6-methylpyridin-2-ylmethoxyimino)ethyl]benzyl)carbamate, methyl 2-(ortho-((2,5-dimethylphenyloxymethylene)phenyl)-3-methoxyacrylate;

Carboxamides
carboxanilides: for example benalaxyl, benodanil, boscalid, carboxin, mepronil, fenfuram, fenhexamide, flutolanil, furametpyr, metalaxyl, ofurace, oxadixyl, oxycarboxin, penthiopyrad, thifluzamide, tiadinil, 4-difluoromethyl-2-methylthiazole-5-(4′-bromobiphenyl-2-yl)carboxamide, 4-difluoromethyl-2-methylthiazole-5-(4′-trifluoromethylbiphenyl-2-yl)carboxamide, 4-difluoromethyl-2-methylthiazole-5-(4′-chloro-3′-fluorobiphenyl-2-yl)carboxamide, 3-difluoromethyl-1-methylpyrazole-4-(3′,4′-dichloro-4-fluorobiphenyl-2-yl)carboxamide, 3-difluoromethyl-1-methylpyrazole-4-(3′,4′-dichloro-5-fluorobiphenyl-2-yl)carboxamide, 3,4-dichloroisothiazole-5-(2-cyanophenyl)carboxamide;
carboxylic acid morpholides: dimethomorph, flumorph;
benzamides: flumetover, fluopicolide (picobenzamid), zoxamide;
other carboxamides: carpropamid, diclocymet, mandipropamid, N-(2-(4-[3-(4-chlorophenyl)prop-2-inyloxy]-3-methoxyphenyl)ethyl)-2-methanesulfonylamino-3-methyl-butyramide, N-(2-(4-[3-(4-chlorophenyl)prop-2-inyloxy]-3-methoxyphenyl)ethyl)-2-ethanesulfonylamino-3-methylbutyramide,

Azoles
triazoles: bitertanol, bromuconazole, cyproconazole, difenoconazole, diniconazole, enilconazole, epoxiconazole, fenbuconazole, flusilazole, fluquinconazole, flutriafol, hexaconazole, imibenconazole, ipconazole, metconazole, myclobutanil, penconazole, propiconazole, prothioconazole, simeconazole, tebuconazole, tetraconazole, triadimenol, triadimefon, triticonazole;
imidazoles: cyazofamid, imazalil, pefurazoate, prochloraz, triflumizole;
benzimidazoles: benomyl, carbendazim, fuberidazole, thiabendazole;
others: ethaboxam, etridiazole, hymexazole;

Nitrogen-comprising heterocyclyl compounds
pyridines: fluazinam, pyrifenox, 3-[5-(4-chlorophenyl)-2,3-dimethylisoxazolidin-3-yl]pyridine;
pyrimidines: bupirimate, cyprodinil, ferimzone, fenarimol, mepanipyrim, nuarimol, pyrimethanil;
piperazines: triforine;
pyrroles: fludioxonil, fenpiclonil;
morpholines: aldimorph, dodemorph, fenpropimorph, tridemorph;
dicarboximides: iprodione, procymidone, vinclozolin;
others: acibenzolar-S-methyl, anilazin, captan, captafol, dazomet, diclomezine, fenoxanil, folpet, fenpropidin, famoxadone, fenamidone, octhilinone, probenazole, proquinazid, pyroquilone, quinoxyfen, tricyclazole, 2-butoxy-6-iodo-3-propylchromen-4-one, 3-(3-bromo-6-fluoro-2-methylindole-1-sulfonyl)-[1,2,4]triazole-1-dimethylsulfonamide;

Carbamates and dithiocarbamates
dithiocarbamates; ferbam, mancozeb, maneb, metiram, metam, propineb, thiram, zineb, ziram;
carbamates: diethofencarb, flubenthiavalicarb, iprovalicarb, propamocarb, methyl 3-(4-chloro-phenyl)-3-(2-isopropoxycarbonylamino-3-methylbutyrylamino)propionate, 4-fluorophenyl N-(1-(1-(4-cyanophenyl)ethanesulfonyl)but-2-yl)carbamate;

Other fungicides
guanidines: dodine, iminoctadine, guazatine;
antibiotics: kasugamycin, polyoxine, streptomycin, validamycin A;
organometallic compounds: fentin salts;
sulfur-comprising heterocyclyl compounds: isoprothiolane, dithianon;
organophosphorus compounds: edifenphos, fosetyl, fosetyl-aluminum, iprobenfos, pyrazophos, tolclofos-methyl, phosphorous acid and its salts;
organochlorine compounds: thiophanate methyl, chlorothalonil, dichlofluanid, tolylfluanid, flusulfamide, phthalide, hexachlorobenzene, pencycuron, quintozene;
nitrophenyl derivatives: binapacryl, dinocap, dinobuton;
inorganic active ingredients: Bordeaux mixture, copper acetate, copper hydroxide, copper oxychloride, basic copper sulfate, sulfur;
others: spiroxamine, cyflufenamid, cymoxanil, metrafenone.

Depending on the fungicidal active ingredient present in the composition, the composition can be used for protecting the woody plant from infection with the following fungal pathogens or for the treatment of an infection with these fungal pathogens and/or a disease caused by them.

Botryosphaeria species, Cylindrocarpon species, Eutypa lata, Neonectria liriodendri and Stereum hirsutum,

Ascomycetes, Deuteromycetes, Basidiomycetes, Peronosporomycetes (syn. Oomycetes), and Fungi imperfecti.

Ascomycetes such as Ophiostoma spp., Ceratocystis spp., Aureobasidium pullulans, Sclerophoma spp., Chaetomium spp., Humicola spp., Petriella spp., Trichurus spp.; Basidiomycetes such as Coniophora spp., Coriolus spp., Gloeophyllum spp., Lentinus spp., Pleurotus spp., Poria spp., Serpula spp. and Tyromyces spp., Deuteromycetes such as Aspergillus spp., Cladosporium spp., Penicillium spp., Trichoderma spp., Alternaria spp., Paecilomyces spp. and Zygomycetes such as Mucor spp.

Glomerella cingulata, Guignardia budelli, Isariopsis clavispora Phomopsis species such as, for example, P. viticola, Plasmopara viticola, Pseudopezicula tracheiphilai, Erysiphe (syn. Uncinula) necator

In one embodiment, the present invention is particularly suitable for the protection against, and the treatment of, diseases caused by:

Phaeomoniella chlamydospora, aleophilum, parasiticum

Phaeoacremonium spp. (aleophilum, inflatipes, chlamydosporum, angustius, viticola, rubrigenum, parasiticum)

Formitipora mediterranea (syn. Phellinus punctatus, Phellinius igniarius Fomitiporia punctata)

Eutypa lata, Eutypa armeniacae, Libertella blepharis

Stereum hirsutum

Phomopsis viticola, amygdalii

Botryosphaeria spp. (australis, dothidea, obtusa, stevensii, parva, rhodina)

Cylindrocarpon spp. (destructans, optusisporum)

Campylocarpon spp.

Guignardia bidwellii, rubrigenum)

Elsinoe ampelina

Verticilium

Armillaria mellea

Clitopilus hobsonii

Flammulina velutipes

Pleurotus pulmonarius

Inonotus hispidus

Trametes hirsuta, Trametes versicolor

Peniphora incarnate

Hirneola auriculae-judae

Diaporthe helianthi, ambigua

Pleurostomophora sp.

Cadophora sp.

Phialemonium sp.

In one embodiment, the compositions according to the invention are particularly suitable for the protection against, and the control of, Elsinoe ampelina on grapevines.

In a preferred embodiment, the composition according to the invention is used for the protection of woody plants, specifically grapevines, from esca, i.e. for the protection of woody plants, specifically grapevines, from an infection with the complex of pathogens which are associated with the disease esca. The compositions according to the invention can also be used for the treatment of esca in woody plants, specifically grapevines, or for the treatment of woody plants which are infected with the esca-causing pathogens. As already explained above, this disease is frequently caused in central Europe by the main pathogens Phaeomoniella chlamydospora, Phaeoacremonium spp. (aleophilum, inflatipes, chiamydosporum), and Formitipora mediterranea (syn. Phellinus punctatus, Fomitiporia punctata). In this case, the composition according to the invention preferably comprises at least one strobilurin, in particular at least one strobilurin indicated as being preferred, and specifically pyraclostrobin, if appropriate in combination with at least one further plant protectant, specifically a fungicide, where what has been said above with regard to preferred combinations also applies here.

The compositions according to the invention are suitable for the protection against, or the treatment of esca in a wide range of grapevine varieties. Examples of grapevine varieties are white wine and red wine grapevine varieties, for example white grapevine varieties such as Müller-Thurgau, Bacchus, Riesling, Scheurebe, Silvaner, Kerner, Gutedel, Faberrebe, Ortega, Huxelrebe, Elbling, Morio-Muskat, Sultana, Chardonnay, Airén, Trebbiano and Trebbiano variations, Regina, Chemn blanc, Pardillo, Muscat gold, Macabeo, Welschriesling, Palomino, Gutedel, Semillon, Colombard, Fernao Pires, Pedro Ximénez, Green Veltliner, Pinot gris, Pinot blanc, Catarratto bianco, Garganega, Muscadet, Parellada, Sauvingnon blanc and Gewurztraminer, and also red grapevine varieties such as Dornfelder, Lemberger, Tempranillo, Carignan, Grenache noir, Merlot, Cabernet Sauvignon, Sangiovese, Shiraz, Bobal, Monastrell, Isabella, Pinot noir, Pais, Cinsault, Cabernet franc, Gamay, Cereza, Criaolla, Kadarka, Alicante Bouschet, Concord, Cardinale, Zinfandel, Malbec, Primitivo, Pinot meunier, Regent, St Laurent, Acolon, Dunkelfelder, Cabernet Mitos, Dorsa, Cubin, Dorio, Portugieser, Mencia, Chelva and Trollinger.

In another embodiment, the composition according to the invention comprises at least one active ingredient against bacteria, preferably at least one active ingredient which is active against Agrobacterium vitis and/or phytoplasmas. The bactericidally active ingredient can be present in the compositions according to the invention alone or together with one or more other active ingredients, in particular fungicidally active ingredients and specifically one or more active ingredients from the group of the strobilurins.

In a further embodiment, the compositions according to the invention comprise at least one insecticide. The insecticide may be present in the compositions according to the invention alone or together with one or more other active ingredients, in particular fungicidal active ingredients and specifically one or more active ingredients from the group of the strobilurins.

The groups of substances detailed in the following list of insecticide groups are examples of classes of substances which may be present in the compositions according to the invention. The enumeration is intended to illustrate, but does not limit the insecticides to those listed herein below.

Organo(thio)phosphates, carbamates, pyrethroids, juvenile hormone mimetics, nicotinic receptor agonists/antagonists, GABA-gated chloride channel antagonists, chloride channel activators, METI I, II or III compounds, decoupler of oxidative phosphorylation, inhibitors of oxidative phosphorylation, molting inhibitors, synergists, sodium-channel-blocking compounds, fumigants, selective feeding blockers, mite growth inhibitors, chitin synthesis inhibitors, lipid biosynthesis inhibitors, ryanodin receptor modulators, anthranilamides, malononitrile compounds and microbial disruptors (such as, for example: Bacillus thuringiensis).

From among these groups, compounds are commercially available or are known from the literature, for example from The Pesticide Manual, 13th Edition, British Crop Protection Council (2003).

In a particular embodiment, the surface sealants according to the invention comprise insecticides which the skilled worker knows are active against the following insects:
Homoptera: Cicadidae: periodical cicada (Magiciada septendecim), Magicicada cassini, Magicicada septendecula
   Coccidae: European fruit lecanium (Lecanium corni)
   Cocoidea: Schildläuse (Pulvinaria vitis, Heliococcus bohemicus, Phenaloccus aceris)
   Diaspididae: Diaspidiotus uvae (grape scale)
Hemiptera: Pseudococcidae: grape mealybug (Pseudococcus maritimus, Planococcus ficus)
   Phylloxera: phylloxera (Viteus vitifoliae), root aphids (Pemphigus bursarius)
Coleoptera: Curculionidae: Ampeloglypter sesostris (grape cane gallmaker), Ampeloglypter ampelopsis (grape cane girdler), ambrosia beetles (Xylosandrus germanus, Xyleborinus saxeseni)
   Chrsomelidae: Fidia viticida (grape rootworm)
   Cerambycidae: Clytoleptus albobasciatus (grape trunk borer)
   Scolytidae: European shot-hole borer (Xyleborus dispar), black stem borer (Xylosandrus germanus)
Lepidoptera: Sesiidae: Vitacea polistiformis (grape root borer)
   Tortricidae: European grape moth (Eupoecilia amiguella), European vine moth (Lobesia botrana)
Orthoptera: Gryllidae: Oecanthus fultoni (snow tree cricket)
Thysanoptera: Thripidae: thrips (Thysanoptera), inter alia Rebenthrips (grapevine thrips)
Arachnida: Acari: grape rust mites (Calepitrimerus vitis), vine leaf blister mite
Isoptera: termites

In another embodiment, the composition comprises at least one active ingredient against bacteria, in particular an active ingredient which is effective against Agrobacterium vitis and/or phytoplasmas.

In one embodiment, the compositions according to the invention comprise resistance stimulators for plants, preferably messenger-substance-like substances or substances which modify the activity of messenger substances. The compositions according to the invention comprise the resistance stimulators preferably in combination with at least one fungicide or insecticide. Especially preferred substances are those which have the activity of ethylene, salicylic acid or jasmonates or which modify the activity of these endogenous substances in the plant. Very specially preferred are methyl jasmonate and benzoic acid derivatives. Salicylic acid is the most preferred.

Besides the sealing material and the plant protectant, the sprayable compositions and also the flowable compositions according to the invention comprise at least one volatile diluent.

Volatile diluents are understood as meaning, besides water, also organic solvents with a boiling point below 150° C. at 1 bar. The diluent serves to dissolve or to disperse or to emulsify the components a) and b).

Suitable volatile diluents are water, C₁-C₆-alkanols, in particular C₂-C₄-alkanols such as ethanol, n- and iso-propanol, n-butanol, ketones having 3 to 6 C atoms such as acetone, methyl ethyl ketone, cyclohexanone, furthermore ethylene glycol and mixtures of these solvents, in particular mixtures with water. In a preferred embodiment of the invention, the diluent is an aqueous diluent, i.e. water or a mixture of water and one of the abovementioned organic solvents which are largely or fully miscible with water, with water being the main component and accounting for, in particular at least 70% by volume, in particular at least 80% by volume and specifically at least 90 or 95% by volume, based on the total amount of diluent, for example water or a mixture of water with an organic solvent which is selected from among C₂-C₄-alkanols, ketones with 3 to 6 C atoms and ethylene glycol.

The amount of diluent can be varied within wide limits and is generally at least 50% by weight, frequently at least 55% by weight, particularly at least 60% by weight. It is typically in the range from 50% to 99.84% by weight, frequently in the range from 55% to 99.8% by weight and specifically in the range from 60% to 99.5% by weight or in the range from 60% to 99.3% by weight or in the range from 60% to 98.85% by weight or in the range from 60% to 97.9% by weight or in the range from 60% to 95.9% by weight or in the range from 60% to 92.8% by weight, all based on the total weight of the composition. If appropriate, it may be advantageous to dilute the composition prior to application, for example to 1.5 to 100 times its initial volume.

Besides the abovementioned components a), b) and c), the compositions according to the invention comprise at least one nonionic surface-active substance as component d), in particular at least one nonionic surface-active substance which has at least one poly-C₂-C₃-alkylene oxide group. This substance improves the penetration of the active ingredient into the wood of the treated plant and will, as a rule, also lead to the formation of a better seal on the treated wound area.

Preference is given to nonionic surface-active substances, at a concentration of 0.25%, at least halve the surface tension of water at 20° C. This skilled worker is familiar with the methods for determining the surface tension, for example from DIN EN 14 370 and DIN 53914.

Preference is given to nonionic surface-active substances with a Griffin HLB value (see J. Soc. Cosmet. Chem. 1, 311 (1950) and 5, 249, (1954 and H. Mollet et al. Formulation Technology, Wiley-VCH 2001, p. 70-72) of not more than 14, for example in the range of from 7 to 14 and specifically in the range of from 10 to 14.

Examples of suitable nonionic surface-active substances are in particular compounds which have a hydrophobic moiety, for example a C₈-C₂₀-alkyl radical, a C₄-C₂₀-alkylphenyl radical, 1, 2 or 3 fatty acid radicals which are optionally linked with one another via a polyol, and at least one, for example 1 or 2, polyalkylene oxide groups, in particular poly-C₂-C₃-alkylene oxide groups, for example:
Poly-C₂-C₃-alkoxylated C₈-C₂₀-alkanols, in particular poly-C₂-C₃-alkoxylated n-decanol, poly-C₂-C₃-alkoxylated n-dodecanol, poly-C₂-C₃-alkoxylated isotridecanol, poly-C₂-C₃-alkoxylated myristyl alcohol, poly-C₂-C₃-alkoxylated cetyl alcohol, poly-C₂-C₃-alkoxylated stearyl alcohol
Poly-C₂-C₃-alkoxylated C₄-C₂₀-alkylphenols such as poly-C₂-C₃-alkoxylated butylphenol, poly-C₂-C₃-alkoxylated octylphenol, poly-C₂-C₃-alkoxylated nonylphenol,
Poly-C₂-C₃-alkoxylated mono-, di- or tristyryl phenyl ethers.
Polyethoxylated castor oil,
Poly-C₂-C₃-alkoxylated sorbitan fatty acid esters such as poly-C₂-C₃-alkoxylated sorbitan trioleate and
Polyalkylene-oxide-modified siloxanes, in particular poly-C₂-C₃-alkylene-oxide-modified siloxanes, especially preferably polyalkylene-oxide-modified oligomeric polymethylsiloxanes (degree of oligomerization preferably 2 to 6), very especially preferably poly-C₂-C₃-alkylene-oxide-modified oligomeric polymethylsiloxanes (degree of oligomerization preferably 2 to 6), particularly preferably polyalkylene-oxide-modified heptamethyltrisiloxanes, most preferably poly-C₂-C₃-alkylene-oxide-modified heptamethyltrisiloxanes.

Polyalkoxylated, or polyalkylene-oxide-modified, means that the substances have at least one polyether chain which is composed of recurrent C₂-C₃-alkylene oxide units (poly-C₂-C₃-alkoxylated, or poly-C₂-C₃-alkylene-oxide-modified), i.e. of recurrent ethylene oxide units (—CH₂CH₂O—) and/or recurrent propylene oxide units (—CH(CH₃)CH₂O—). The number of the recurrent units depends in the manner known per se on the type of the hydrophobic moiety and the amount of recurrent propylene oxide units and is preferably in the range of from 4 to 20, specifically in the range of from 4 to 15.

In an especially preferred embodiment, the nonionic surface-active substances d) used are hydrophilically modified siloxanes such as, for example, the substances present in the products of the Silwet L (Union Carbide or OSi Specialities, Inc or Leu+Gygax AG), or Sylgard® 309 (Dow Corning) brands. Among these, preference is given in particular to polyalkylene-oxide-modified siloxanes, in particular to poly-C₂-C₃-alkylene-oxide-modified siloxanes. Very particular preference is given to polyalkylene-oxide-modified oligomeric polymethylsiloxanes (degree of oligomerization preferably 2 to 6), in particular poly-C₂-C₃-alkylene-oxide-modified oligomeric polymethylsiloxanes (degree of oligomerization preferably 2 to 6). Most preferred are polyalkylene-oxide-modified heptamethyltrisiloxanes, in particular poly-C₂-C₃-alkylene-oxide-modified heptamethyltrisiloxanes, specifically for example the polyalkylene-oxide-modified heptamethyltrisiloxanes present in Silwet L-77 (Leu+Gygax AG), Ranman Komponente B (ISK Bioscience Europe S.A.) or Pentra-Bark (Agrichem).

The compositions according to the invention comprise the abovementioned nonionic surface-active substances in an amount of at least 10% by weight, especially preferably at least 15% by weight or 20% by weight, for example in an amount of from 5 to 100% by weight, in particular 10 to 80% by weight, especially preferably 15 to 70% by weight or 20 to 60% by weight, based on the sealing material (component a). Based on the total weight of the composition, the amount of the nonionic surface-active substance is, as a rule, in the range of from 0.5 to 20% by weight, in particular 1 to 18% by weight or 2 to 15% by weight. In principle, lower concentrations of nonionic surface-active substances are also possible in sprayable compositions, for example in the range of from 0.05 to 20% by weight, in particular in the range of from 0.05 to 18% by weight or in the range of from 0.05 to 15% by weight.

In accordance with an especially preferred embodiment of the invention, the compositions according to the invention comprise, as sealing material a), at least one polar polyethylene-based wax, i.e. a polyethylene oxidate wax or a carboxyl-group-bearing copolymer of ethylene as defined hereinabove, as active ingredient b), at least one active ingredient from the group of the strobilurins, in particular at least one of the strobilurins mentioned as being preferred, specifically pyraclostrobin, if appropriate in combination with one or more further fungicidal active ingredients, for example in combination with one or more conazole fungicides, specifically epoxiconazole, at least one solvent or diluent, specifically an aqueous diluent and at least one nonionic surface-active substance in an amount of at least 10% by weight, especially preferably at least 15% by weight or 20% by weight, for example in an amount of from 10 to 100% by weight, in particular from 10 to 80% by weight, especially preferably from 15 to 70% by weight or 20 to 60% by weight, based on the sealing material, with the nonionic surface-active substance comprising at least one poly-C₂-C₃-alkylene oxide group and in particular a poly-C₂-C₃-alkylene-oxide-modified polymethylsiloxane and specifically a poly-C₂-C₃-alkylene-oxide-modified heptamethyltrisiloxane. As regards the concentrations and relative proportions of the components a), b), c) and d) in the composition and the viscosity, what has been said above also applies here. In particular, it is a sprayable formulation.

In accordance with another especially preferred embodiment of the invention, the compositions according to the invention comprise, as sealing material a), at least film-forming acrylate polymer, in particular a weakly crosslinked acrylate rubber and specifically a butyl acrylate rubber, as active ingredient b), at least one active ingredient from the group of the strobilurins, in particular at least one of the strobilurins mentioned as being preferred, specifically pyraclostrobin, if appropriate in combination with one or more further fungicidal active ingredients, for example in combination with one or more conazole fungicides, specifically epoxiconazole, at least one solvent or diluent, specifically an aqueous diluent and at least one nonionic surface-active substance in an amount of at least 5% by weight, in particular at least 10% by weight, especially preferably at least 15% by weight or 20% by weight, for example in an amount of from 5 to 100% by weight, in particular from 10 to 80% by weight, especially preferably from 15 to 70% by weight or 20 to 60% by weight, based on the sealing material, with the nonionic surface-active substance comprising at least one poly-C₂-C₃-alkylene oxide group and in particular a poly-C₂-C₃-alkylene-oxide-modified polymethylsiloxane and specifically a poly-C₂-C₃-alkylene-oxide-modified heptamethyltrisiloxane. As regards the concentrations and relative proportions of the components a), b), c) and d) in the composition and the viscosity, what has been said above also applies here. In particular, it is a sprayable formulation.

Besides the abovementioned constituents a), b), c) and d) the compositions may comprise further constituents in minor quantities, for example surface-active substances, unless already present in component d), bactericides, antifoams, colorants and the like.

Surface-active substances which are suitable in this context are, for example, anionic surface-active substances, for example the alkali, alkaline earth or ammonium salts of aromatic sulfonic acids, for example lignin-, phenol-, naphthalene- and dibutyl-naphthalenesulfonic acid, and of fatty acids, of arylsulfonates, of alkyl ethers, of lauryl ethers, of fatty alcohols sulfates and of fatty alcohol glycol ether sulfates, condensates of sulfonated naphthalene and its derivatives with formaldehyde, condensates of naphthalene, or of the naphthalenesulfonic acids, with phenol and formaldehyde, condensates of phenol, or of phenolsulfonic acid, with formaldehyde, condensates of phenol with formaldehyde and sodium sulfite, lignin sulfite waste liquors, salts of phosphated tristyrylphenol ethoxylates or their mixtures. Others which are suitable are nonionic surface-active substance unless already present in component d), for example ethoxylated alkanols such as ethoxylated isotridecyl alcohol, ethoxylated alkylphenols such as ethoxylated isooctyl-, octyl- or nonylphenol, tributylphenyl polyglycol ether, ethoxylated castor oil, ethoxylated tristylrylphenols, lauryl alcohol polyglycol ether acetate and sorbitan esters.

Antifoams which may be present in the surface sealants according to the invention are all those antifoams conventionally used for the formulation of agrochemical active ingredients. Examples of antifoams are silicone emulsions (such as, for example, Silikon® SRE, Wacker or Rhodorsil® from Rhodia), long-chain alcohols, fatty acids, organofluorin compounds and mixtures of these.

Bactericides can be added to stabilize the compositions according to the invention against attack by microorganisms. Suitable bactericides which may be present in the surface sealants according to the invention are all those conventionally used for the formulation of agrochemical active ingredients, such as, for example, bactericides based on dichlorophen and benzyl alcohol hemiformal, and isothiazolones such as Proxel® from ICI or Acticide® RS from Thor Chemie and Kathon® MK from Rohm & Haas.

In one embodiment, the compositions according to the invention do not contain any viscosity-modified constituents (with the exception of the constituents a), b), c) and, if appropriate, d)) or such constituents in a noneffective amount only. As a rule, such compositions exhibit Newtonion flow properties.

In another embodiment, the compositions according to the invention comprise additives which impart to the composition pseudoplastic or thixotropic properties, i.e. high viscosity upon standing and low viscosity upon the action of shear forces.

Examples of colors are both pigments, which are sparingly soluble in water, and dyes, which are soluble in water. Examples which may be mentioned are the dyes known as Rhodamin B, C.I. Pigment Red 112 and C.I. Solvent Red 1, and Pigment blue 15:4, Pigment blue 15:3, Pigment blue 15:2, Pigment blue 15:1, Pigment blue 80, Pigment yellow 1, Pigment yellow 13, Pigment red 112, Pigment red 48:2, Pigment red 48:1, Pigment red 57:1, Pigment red 53:1, Pigment orange 43, Pigment orange 34, Pigment orange 5, Pigment green 36, Pigment green 7, Pigment white 6, Pigment brown 25, Basic violet 10, Basic violet 49, Acid red 51, Acid red 52, Acid red 14, Acid blue 9, Acid yellow 23, Basic red 10, Basic red 108.

The compositions according to the invention are prepared by mixing the components a), b), c) and, if appropriate, d) and the further constituents which may be present by known formulation technology methods for liquid compositions. As a rule, a procedure will be followed in which the sealing material is introduced, into the reaction vessel, in the diluent in dissolved or dispersed form and the further constituents are incorporated, if appropriate, with addition of further diluent. It is preferred to employ the sealing material in the form of an aqueous dispersion. Likewise, it is preferred to employ the active ingredient in the form of a solution, a suspension or an emulsion, preferably in the diluent or in a fluid phase capable of being mixed with, or emulsified in, the diluent.

The application of the compositions onto the wound areas of woody plants, to be protected or to be treated can be effected in a customary manner and depends in a known manner on the nature of the wound to be treated or to be protected.

During the application, the surface of the wound area is firstly impregnated, whereby active ingredient and, if appropriate, the sealant penetrates the surface zone. The sealing material, in turn, forms a permanently elastic continuous layer or film on or in the wood surface or wound surface and thus seals the wound against the penetration of plant pathogens. The layer which has formed is resistant to weathering, frost, UV, rain and abrasion and nonphytotoxic.

Spray application succeeds in achieving good depth of penetration into the plant material, with the penetration preferably taking place towards the vascular bundles. Frequently, the depth of penetration is at least 0.2 cm, in particular at least 0.5 cm and especially preferably at least 1 cm, up to 2.5 cm or 3 cm or more.

The wounds to be treated or to be protected may take the form of natural injuries as they arise as the result of windbreak, frost or other atmospheric influences, or they may take the form of the wound areas caused by pruning. They may be wounds in the bark zone, or else wounds in the cross-section of the wood, i.e. wounds caused by sawing or cutting.

In accordance with the preferred embodiment, the application is effected by spraying the composition at least onto the wound zone. The term “spraying” also comprises the nebulizing, blowing and splashing-on of the composition. The equipment used for spraying may be customary equipment such as, for example, commercially available atomizers, spraying apparatus, manual sprayers, and pneumatic or manual pruning shears with spray function by means of which the compositions can be applied in a targeted manner to pruning wounds within the scope of the usual spraying procedure.

The application can be effected in a targeted manner in the wound zone, or the compositions can be applied over a large area of the woody part of the plant so that the plant parts which are located in spatial vicinity to the wound(s) are also treated with the composition. In accordance with an especially preferred embodiment of the invention, the application is effected by what is known as tunnel spraying, where, in plantations of fruit trees or grapevines, the woody parts after a pruning treatment are sprayed in a targeted manner in the pruning zone with a composition according to the invention, if appropriate after dilution, and excess spray liquor is collected. In this manner, the pruning sites and surrounding woody parts are treated.

The application of the compositions preferably takes place at temperatures in the range of from −10° C. to +30° C., especially preferably in the range of from −5° C. to +20° C. and very especially preferably in the range of from −3° C. to +10° C.

In one embodiment, the composition according to the invention is used in a multi-step method. Thus, for example, it is possible to apply, to the surface to be treated or to be protected of the woody plant, in a first pass, a first plant protectant, in particular a fungicide, or an active ingredient preparation of this active ingredient, and the composition according to the invention is then applied in one of the subsequent passes in the manner described herein.

The composition according to the invention can be used in any woody plant crop, including in crops which are tolerant to attack by insects, viruses, bacteria or fungi or to the application of herbicides as the result of breeding, including genetic engineering methods. In particular, the crops according to the invention are employed for the treatment of fruit trees such as plum, peach, cherry, apple, pear, Syrian plum, and specifically for the treatment of grapevines.

The examples and figures which follow are intended to illustrate the invention.

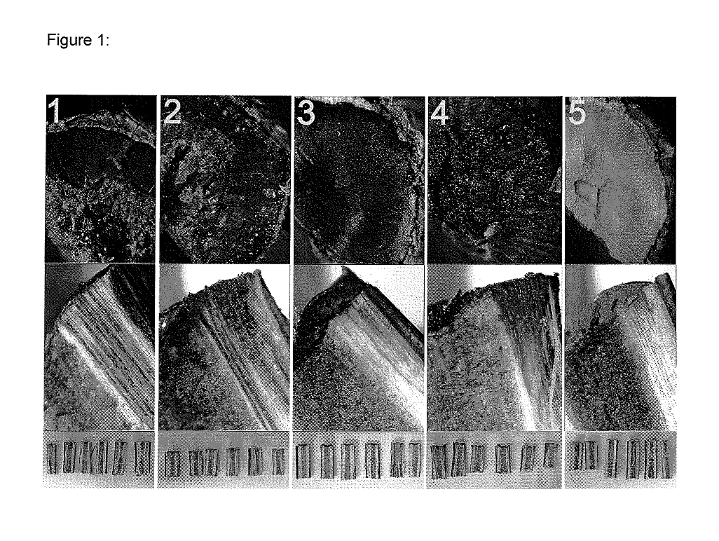

FIG. 1 shows light micrographs of cuts along the fiber axis of various grapevine wood sections treated in accordance with the invention. The upper row shows in each case top views of the pruning site treated. The second row shows a longitudinal section in the zone of the pruning site treated. The bottom row shows the longitudinal section of several treated grapevine wood sections.

Materials

Sealing material 1: Crosslinked polybutyl acrylate in the form of 40% by weight anionically stabilized aqueous polymer dispersion, prepared analogously to Example 1, A1 of EP0099532.

Sealing material 2: Oxidized polyethylene wax, acid number (DIN EN ISO 2114) 20-24 mg KOH/g, melting point (DIN 51007) 126-133° C., melt viscosity (120° C., DIN 51526) 4500 mm/sec²; in the form of a 30% by weight aqueous suspension with a mean particle size of 100 nm, a viscosity (DIN EN ISO 2431, cup 4) of 20-36 s⁻¹ and pH 9, comprising approximately 7% by weight of an ethoxylated fatty alcohol, 0.4% by weight of diethylethanolamine and approximately 0.6% by weight of potassium hydroxide.

Sealing material 3: Oxidized polyethylene wax, acid number (DIN EN ISO 2114) 17.5-19 mg KOH/g, melting point (DIN 51007) 126-133° C., melt viscosity (120° C., DIN 51526) 6500 mm/sec²; in the form of a 30% by weight aqueous suspension with a mean particle size of 100 nm, a viscosity (DIN EN ISO 2431, cup 4) of 20-60 s⁻¹ and pH 8.5, comprising approximately 9% by weight of an ethoxylated oxo alcohol, and approximately 0.5% by weight of potassium hydroxide.

Sealing material 4: Copolymer of 90% by weight of ethylene and 10% by weight of methacrylic acid with a melt viscosity (120° C., DIN 51526) 1400 mm/sec², in the form of approximately 20% by weight aqueous emulsifier-free dimethylethanolamine-neutralized dispersion.

Sealing material 5: Copolymer of 80% by weight of ethylene and 20% by weight of methacrylic acid with an MFI value of 10 (measured at 160° C. under a load of 325 g as specified in DIN 53753) in the form of approximately 25% by weight aqueous emulsifier-free dimethylethanolamine-neutralized dispersion.

Surface-active substance I: Ethoxylated heptamethyltrisiloxane 89% pure, for example Silwet L-77 (Leu+Gygax AG, Birmenstorf CH) or Pentra-Bark (Agrichem Manufacturing Industries, Loganholme AU)

Colorant I: 40% by weight of liquid preparation of a red xanthene dye (C.I. Basic Violet 10 Acetate);

Colorant II: 50% by weight dispersion of the colorant C.I. Pigment Red 112 in a mixture of water, dipropylene glycol (volume ratio 2:1) and nonionic emulsifier (10%, based on the colorant).

Preparation of the Formulations:

7 parts by weight of the aqueous dispersions of the sealing materials were mixed, in a stirred vessel, in each case with 0.1 part by weight of colorant I (liquid preparation) and, if appropriate, with 1 part by weight of the surface-active substance I until homogeneous. Here, the colorant was used to represent a fungicidal active ingredient and serves to visualize the penetration of the composition or the active ingredient into the woody material.

| | | | SAS I ²) | Viscosity ⁴⁾ | | |
|---|---|---|---|---|---|---|
| Formula- | Sealant | % by | % by | T[° C.] | | |
| tion No. | No. | weight ¹⁾ | weight ¹⁾ | (K/P) ⁵⁾ | | [mPa · s] |
| 1V ³⁾ | 2 | 30 | — | 0 | (K) | 71.0 |
| | | | | 5 | (K) | 61.6 |
| | | | | 10 | (K) | 54.0 |
| | | | | 20 | (K) | 42.5 |
| 2 | 2 | 26 | 11.2 | 0 | (K) | 132.4 |
| | | | | 5 | (K) | 101.3 |
| | | | | 10 | (K) | 90.0 |
| | | | | 20 | (K) | 134.5 |
| 3V | 1 | 40 | — | 0 | (P) | 6.6 |
| | | | | 5 | (P) | 5.6 |
| | | | | 10 | (P) | 4.9 |
| | | | | 20 | (P) | 3.3 |
| 4 | 1 | 35 | 11.2 | 0 | (K) | 60.7 |
| | | | | 5 | (K) | 59.4 |
| | | | | 10 | (K) | 48.8 |
| | | | | 20 | (K) | 42.2 |

| | | | | | |
|---|---|---|---|---|---|
| 5V | 3 | 30 | — | — | n.d. ⁶⁾ |
| 6 | 3 | 26 | 11.2 | — | n.d |
| 7V | 4 | 25 | — | — | n.d |
| 8 | 4 | 22 | 11.2 | — | n.d |
| 9V | 5 | 20 | — | — | n.d |
| 10 | 5 | 17.5 | 11.2 | — | n.d |

¹⁾ % by weight of constituent in formulation
²⁾ Surface-active substance I
³⁾ V = comparative test
⁴⁾ Determined with a rotary viscometer at the stated temperature T and a shear gradient of 100 s⁻¹
⁵⁾ Measuring system: K = cone, 6 cm, 0.59°, 27 μm; P = parallel plate, 6 cm
⁶⁾ n.d.: not determined

The following was employed by way of comparison:

Podexal (BASF Chile)—commercially available wound sealant in paste form, comprising a polyacrylate as sealant, a red colorant and fungicide (pyraclostrobin).

Procedure: To prepare the experiment, several small grapevine wood sections were prepared. To ensure good reproducibility, all grapevine wood sections had a height of approximately 15 mm and a diameter of approximately 8 mm. Moreover, each treatment was carried out in duplicate. The grapevine wood sections were placed on the ground, and treated on the exposed area at the top by applying the composition in question using a disposable pipette.

Podexal was applied using a brush.

Ten days after the application, the grapevine wood sections were cut open along the fiber using pincers. The results for the compositions 1 to 4 and Podexal were evaluated visually under the microscope. The micrographs are shown in FIG. 1, where FIGS. 1/1 to 1/5 show in each case 3 different views of grapevine wood sections of one experiment, where FIG. 1/1 shows the grapevine wood sections treated with composition 1, FIG. 1/2 shows the grapevine wood sections treated with composition 2 etc., and FIG. 1/5 shows the grapevine wood sections treated with Podexal.

Composition 1:

When this composition is applied, a large dome first forms above the section. This dome remains on the surface for a long time until, finally, it penetrates. Deep penetration can be observed.

Composition 2:

The penetration can be improved further by the added SAS I. In each test, the active ingredient, to the extent that this is demonstrated by the colorant, has penetrated down to the end of the specimen.

Composition 3

Upon application, the composition forms a large dome. After the drying time, it can be seen on the microscope that a very strong and elastic coat remains on the exposed area. The penetration depth, to the extent that this is demonstrated by the colorants, is moderate.

Composition 4:

Upon application, the composition forms a large dome. After the drying time, it can be seen on the microscope that a coat remains on the exposed area. The colorant indicates a pronounced and deep penetration, which goes down to the end of the woody section. The layer thickness at the surface is less than in composition 3, probably as the result of the pronounced penetration of the composition into the wood.

### Podexal

After application to the exposed area, Podexal forms a thick protective layer. According to the examination under the microscope, the composition of the protective layer appears to be slightly porous and unelastic.

### EXAMPLE 2

### Sprayability Under Field Conditions

In order to be able to compare the application properties with one another, in each case 7 parts by weight of the aqueous dispersions of the sealing materials 1 to 5 were mixed with 0.1 part by weight of colorant II (instead of an active ingredient) and filled into spray bottles as they are conventionally used for the manual spraying of nasal spray.

Immediately prior to the application, the vine was pruned as for winter pruning. The time which elapsed between the time of application and the time of pruning was five minutes in this experiment.

The surface sealant Podexal had to be painted on since, as the result of the high viscosity of the product, spraying was not possible. The remaining two surface sealants were sprayable and demonstrated a good coverage of the pruning sites, even after 28 days.

1-23. (canceled)

24. A liquid composition comprising
a) a water-insoluble sealing material in dissolved or dispersed form, which is selected from the group consisting of water-insoluble film-forming polymers and waxes and their mixtures;
b) at least one plant protectant,
c) at least one volatile diluent, and
d) at least one nonionic surface-active substance in an amount of from 10 to 100% by weight, based on the sealing material.

25. The composition according to claim 24 which has a dynamic viscosity in the range of from 1 to 500 mPa·s at 20° C.

26. The composition according to claim 24, which is essentially free from polymerizable constituents.

27. The composition according to claim 24, which has a minimum filming temperature (MFT) of not more than 30° C.

28. The composition according to claim 24, where the sealing material is selected from the group consisting of acrylate polymers, waxes and waxy polymers.

29. The composition according to claim 28, where the sealing material is selected from the group consisting of wax oxidates and carboxyl-group-comprising copolymers of ethylene.

30. The composition according to claim 28, where the sealing material is selected from acrylate polymers.

31. The composition according to claim 24, where the sealing material is present in dispersed form in the diluent.

32. The composition according to claim 24, where the diluent comprises at least 70% by weight of water, based on the total amount of diluent.

33. The composition according to claim 24, comprising the at least one sealing material and the at least one plant protectant in a weight ratio of from 1:1 to 10⁶:1.

34. The composition according to claim 24, where the nonionic surface-active substance has at least one poly-C₂-C₃-alkylene oxide group.

35. The composition according to claim 34, where the nonionic surface-active substance comprises at least one poly-C₂-C₃-alkoxylated silane.

36. The composition according to claim 24, where the plant protectant comprises at least one fungicidal plant protectant.

37. The composition according to claim 36, where the fungicidal plant protectant comprises at least one active ingredient which is selected from the group consisting of strobilurins and sterolbiosynthesis demethylation inhibitors (DMI fungicides).

38. The composition according to claim 24, comprising
a) the water-insoluble sealing material in an amount of from 1% to 40% by weight, based on the total weight of the composition;
b) the at least one plant protectant in an amount of from 0.05% to 20% by weight, based on the total weight of the composition;
c) at least one volatile diluent in an amount of at least 50% by weight, based on the total weight of the composition; and
d) at least one nonionic surface-active substance in an amount of from 10% to 100% by weight, based on the sealing material;
wherein said composition is sprayable.

39. The composition according to claim 38, comprising
a) a water-insoluble sealing material in dispersed form selected from acrylate polymers;
b) at least one plant protectant selected from the group consisting of strobilurins and sterol biosynthesis demethylation inhibitors (DMI fungicides);
c) at least one aqueous diluent, and
d) at least one nonionic surface-active substance having at least one poly-C₂-C₃-alkylene oxide group in an amount of from 10% to 100% by weight, based on the sealing material.

40. The composition according to claim 38, comprising
a) a water-insoluble sealing material in dispersed form, which is selected from among polar polyethylene-based waxes;
b) at least one plant protectant selected from the group consisting of strobilurin and sterol biosynthesis demethylation inhibitors (DMI fungicides);
c) at least one aqueous diluent, and
d) at least one nonionic surface-active substance having at least one poly-C₂-C₃-alkylene oxide group in an amount of from 10% to 100% by weight, based on the sealing material.

41. A method of protecting woody plants from infection with phytopathogenic fungi, in particular from esca infection, comprising the spraying of the liquid composition as defined in claim 24, in which the plant protectant comprises at least one fungicidal plant protectant, to wounds in woody plants.

42. The method according to claim 45, where the woody plants are grapevines.
